(19) United States
(12) Patent Application Publication
(10) Pub. No.: US 2024/0319324 A1
(43) Pub. Date: Sep. 26, 2024

(54) SCRAMBLING OF FMCW FOR INTERFERENCE MITIGATION IN JCS

(71) Applicant: QUALCOMM Incorporated, San Diego, CA (US)

(72) Inventors: Kangqi LIU, San Diego, CA (US); Weimin DUAN, San Diego, CA (US); Jing JIANG, San Diego, CA (US)

(21) Appl. No.: 18/186,839

(22) Filed: Mar. 20, 2023

(51) Int. Cl. G01S 7/02

(52) U.S. Cl. CPC G01S 7/0233; G01S 7/0234

(57) ABSTRACT

Apparatuses and methods for scrambling of FMCW for interference mitigation in JCS are described. An apparatus is configured to obtain a set of phase-coded FMCW signals that is phase-coded based on a scrambling ID for the first node and/or a second node. The apparatus is configured to descramble the set of phase-coded FMCW signals based on the scrambling ID. The set of phase-coded FMCW signals is descrambled to obtain a set of descrambled FMCW signals. The apparatus is configured to perform sensing, communication, and/or JCS functions based on the set of descrambled FMCW signals. Another apparatus is configured to configure a set of FMCW signals, and to scramble the set of FMCW signals based on a scrambling ID for the first node and/or a second node to obtain a set of phase-coded FMCW signals. The apparatus is configured to transmit, for the second node, the set of phase-coded FMCW signals.

### TECHNICAL FIELD

The present disclosure relates generally to communication systems, and more particularly, wireless communications utilizing sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to obtain a set of phase-coded frequency modulated continuous wave (FMCW) signals, where the set of phase-coded FMCW signals is phase-coded based on a scrambling identifier (ID) associated with at least one of the first node or a second node. The apparatus is also configured to descramble the set of phase-coded FMCW signals based on the scrambling ID, where the set of phase-coded FMCW signals is descrambled to obtain a set of descrambled FMCW signals. The apparatus is also configured to perform at least one of a sensing function, a communication function, or a joint sensing-communication function based on the set of descrambled FMCW signals.

In the aspect, the method includes obtaining a set of phase-coded FMCW signals, where the set of phase-coded FMCW signals is phase-coded based on a scrambling ID associated with at least one of the first node or a second node. The method also includes descrambling the set of phase-coded FMCW signals based on the scrambling ID, where the set of phase-coded FMCW signals is descrambled to obtain a set of descrambled FMCW signals. The method also includes performing at least one of a sensing function, a communication function, or a joint sensing-communication function based on the set of descrambled FMCW signals.

In an aspect of the disclosure, a method, a computer-readable medium, and an apparatus are provided. The apparatus is configured to configure a set of FMCW signals. The apparatus is also configured to scramble the set of FMCW signals based on a scrambling ID associated with at least one of the first node or a second node, where the set of FMCW signals is scrambled to obtain a set of phase-coded FMCW signals. The apparatus is also configured to transmit, for the second node, the set of phase-coded FMCW signals.

In the aspect, the method includes configuring a set of FMCW signals. The method also includes scrambling the set of FMCW signals based on a scrambling ID associated with at least one of the first node or a second node, where the set of FMCW signals is scrambled to obtain a set of phase-coded FMCW signals. The method also includes transmitting, for the second node, the set of phase-coded FMCW signals

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of use cases for multiple access and waveform implementations, in accordance with various aspects of the present disclosure.

FIG. 6 is a diagram illustrating examples of multiple access and waveforms, in accordance with various aspects of the present disclosure.

FIG. 7 is a call flow diagram for wireless communications, in accordance with various aspects of the present disclosure.

FIG. 8 is a diagram illustrating an example of decoding phase-coded FMCW signals, in accordance with various aspects of the present disclosure.

FIG. 9 is a diagram illustrating examples of signaling and procedures for sensing and communications via scrambling of FMCW signals, in accordance with various aspects of the present disclosure.

FIG. 10 is a diagram illustrating examples FMCW slope and orthogonal frequency division multiplexing (OFDM) numerology, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks, such as a 5G NR network, may enable sensing measurements and operations for wireless devices. For example, a wireless communication network and/or a wireless device may utilize specific waveforms for communications, such as orthogonal frequency division multiplexing (OFDM), and for sensing (e.g., radio frequency (RF), such as FMCW signals). RF sensing operations may include scanning an area by sweeping across one or more beams. RF waveforms may be utilized for joint communications-sensing (JCS) or joint sensing-communications, environment scanning, object detection, weather monitoring, and/or the like. The use of RF waveforms for sensing may provide for low cost, allow flexibility, and allow the re-use of sensing waveforms for multiple purposes. Wireless communication networks may also support and enable RF-based communications between devices thereon.

However, as the bandwidth allocated for wireless/cellular communications systems (e.g., in 5G NR. Enhanced 5G (5G+)) becomes larger and more use cases are introduced with wireless/cellular communications systems, joint communication/RF sensing operations (also functions) (e.g., JCS) utilization may increase further for future cellular systems (e.g., in 6G). As noted, FMCW is used in radio detection and ranging (RADAR) systems due to its low complexity and low cost, which may be further reused for multiple purposes, e.g., sensing, positioning, communications, JCS, etc. For sensing operations, the coexistence of multiple RADAR in congested wireless traffic may be problematic (e.g., with the increasing number of RADAR-equipped vehicles on roadways). The interference caused by other RADAR may negatively affect sensing functionality of a receiver utilizing RADAR for sensing operations, by decreasing signal detection capability. For communications, a receiver may be unable to detect a UE ID (e.g., in UL signaling) or cell ID (e.g., in DL signaling) when receiving legacy, un-coded FMCW signals transmitted by a transmitter. The received FMCW signals may also be interfered with by other FMCW transmitters.

Various aspects relate generally to wireless communications systems and sensing/communication operations for wireless devices. Some aspects more specifically relate to scrambling of FMCW signals for interference mitigation in JCS in wireless communications systems. In one example, a first node may be configured to obtain a set of phase-coded FMCW signals, where the set of phase-coded FMCW signals is phase-coded based on a scrambling ID associated with at least one of the first node or a second node. The first node may also be configured to descramble the set of phase-coded FMCW signals based on the scrambling ID, where the set of phase-coded FMCW signals is descrambled to obtain a set of descrambled FMCW signals. The first node may also be configured to perform at least one of a sensing function, a communication function, or a joint sensing-communication function based on the set of descrambled FMCW signals. In another example, a first node may be configured to configure a set of FMCW signals. The first node may be configured to scramble the set of FMCW signals based on a scrambling ID associated with at least one of the first node or a second node, where the set of FMCW signals is scrambled to obtain a set of phase-coded FMCW signals. The first node may be configured to transmit, for the second node, the set of phase-coded FMCW signals.

Particular aspects of the subject matter described in this disclosure can be implemented to realize one or more of the following potential advantages. In some examples, by utilizing an incorrect ID to decode phase-coded FMCW signals, the described techniques can be used to reduce interference for receivers of phase-coded FMCW signals (e.g., increase signal-to-interference ratios (SIRs)). Additionally, in some examples, by applying the decoding via incorrect IDs for phase-coded FMCW signals to sensing functions, communication functions, JCS or joint sensing-communication functions, and/or the like, the described techniques can be used for larger and more crowded bandwidths in 5G NR, 5G+, and for 6G operations. Accordingly, aspects herein provide for phase-coded FMCW signals for node-specific scrambling/descrambling and interference mitigation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

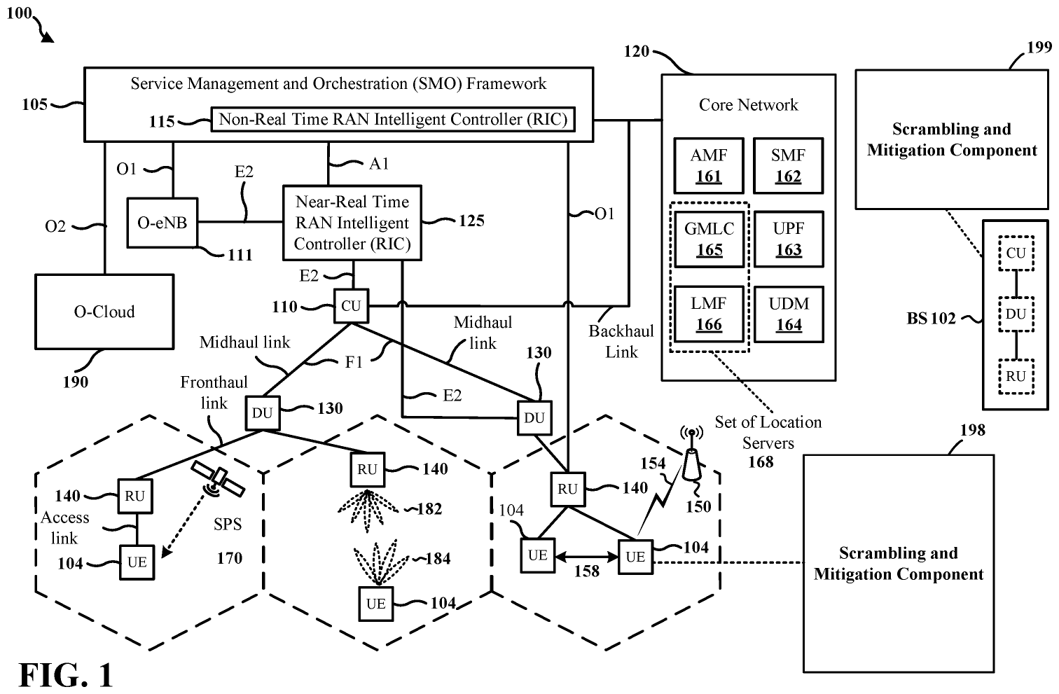

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a scrambling and mitigation component 198 (“component 198”) that may be configured to obtain a set of phase-coded FMCW signals, where the set of phase-coded FMCW signals is phase-coded based on a scrambling ID associated with at least one of the first node or a second node. The component 198 may also be configured to descramble the set of phase-coded FMCW signals based on the scrambling ID, where the set of phase-coded FMCW signals is descrambled to obtain a set of descrambled FMCW signals. The component 198 may also be configured to perform at least one of a sensing function, a communication function, or a joint sensing-communication function based on the set of descrambled FMCW signals. The component 198 may also be configured to transmit, for the second node, a maximum modulated order capability for modulating the sequence of elements. The component 198 may also be configured to receive, from the second node, an indication of a modulated order of the coding waveform, where the modulated order of the coding waveform is less than or equal to the maximum modulated order capability. The component 198 may also be configured to modulate the sequence of elements according to the modulated order of the coding waveform to generate a modulated sequence of elements. The component 198 may also be configured to generate the decoding waveform based on the modulated sequence of elements. The component 198 may also be configured to receive, from the second node, a maximum modulated order capability for modulating the sequence of elements. The component 198 may also be configured to transmit, for the second node, an indication of the modulated order of the coding waveform, where the modulated order of the coding waveform is less than or equal to the maximum modulated order capability. The component 198 may also be configured to obtain, from a network node, an ID indication, where the ID indication indicates the scrambling ID is a node-specific ID for at least one of the monostatic sensing or the bi-static sensing. The component 198 may also be configured to receive, from the second node, an indication of the scrambling ID for at least one of the sensing function, the communication function, or the joint sensing-communication function. The component 198 may also be configured to obtain an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. In certain aspects, the base station 102 may have a scrambling and mitigation component 199 (“component 199”) that may be configured to configure a set of FMCW signals. The component 199 may be configured to scramble the set of FMCW signals based on a scrambling ID associated with at least one of the first node or a second node, where the set of FMCW signals is scrambled to obtain a set of phase-coded FMCW signals. The component 199 may be configured to transmit, for the second node, the set of phase-coded FMCW signals. The component 199 may be configured to obtain the scrambling ID prior to scrambling the set of FMCW signals, where to scramble the set of FMCW signals, the component 199 is configured to scramble the set of FMCW signals based on the obtained scrambling ID. The component 199 may be configured to receive, from the second node, a maximum modulated order capability for modulating the sequence of elements. The component 199 may be configured to transmit, for the second node, an indication of a modulated order of the coding waveform, where the modulated order of the coding waveform is less than or equal to the maximum modulated order capability. The component 199 may be configured to modulate the sequence of elements according to the modulated order of the coding waveform to generate a modulated sequence of elements. The component 199 may be configured to generate the coding waveform based on the modulated sequence of elements. The component 199 may be configured to transmit, for the second node, a maximum modulated order capability for modulating the sequence of elements. The component 199 may be configured to receive, from the second node, an indication of the modulated order of the coding waveform, where the modulated order of the coding waveform is less than or equal to the maximum modulated order capability. The component 199 may be configured to perform at least one of a sensing function, a communication function, or a joint sensing-communication function associated with the set of phase-coded FMCW signals. The component 199 may be configured to obtain an ID indication, where the ID indication indicates the scrambling ID is a node-specific ID for at least one of the monostatic sensing or the bi-static sensing. The component 199 may be configured to transmit, for the second node, an indication of the scrambling ID for at least one of the sensing function, the communication function, or the joint sensing-communication function. The component 199 may be configured to obtain an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. That is, aspects herein provide for phase-coded FMCW signals for node-specific scrambling and interference mitigation. According to the aspects, an incorrect ID may be used to decode phase-coded FMCW signals by which interference may be reduced for receivers of phase-coded FMCW signals (e.g., an increase in a signal-to-interference ratio (SIR)). Additionally, aspects may be applicable to, without limitation, sensing functions, communication functions, JCS or joint sensing-communication functions, and/or the like.

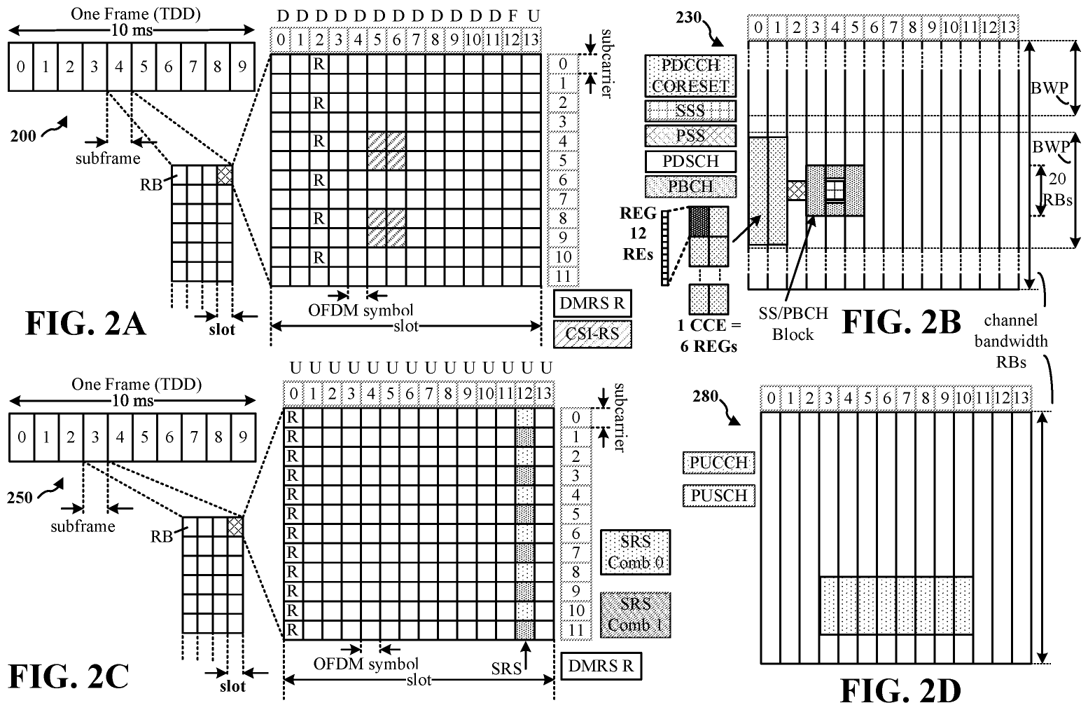

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

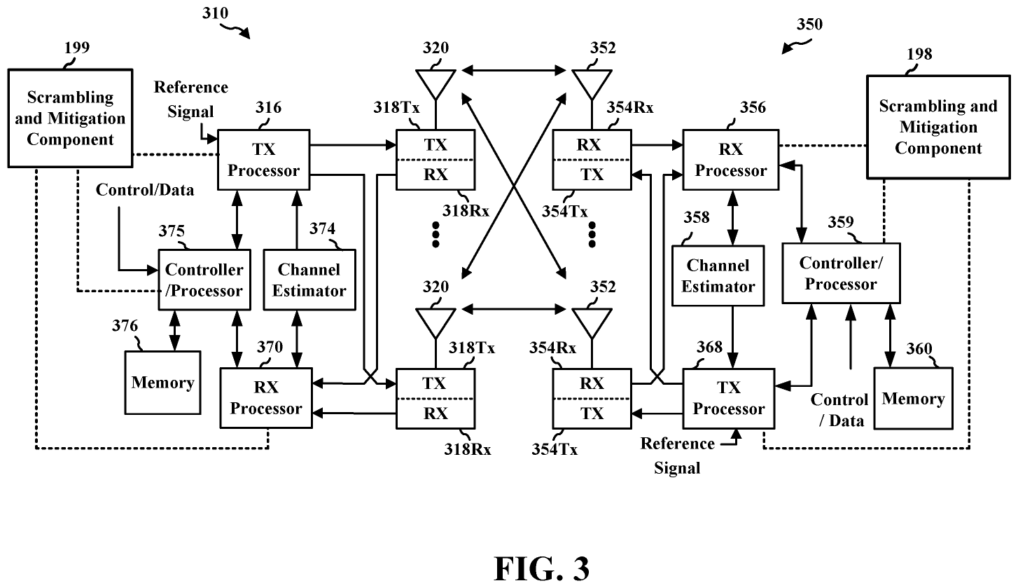

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

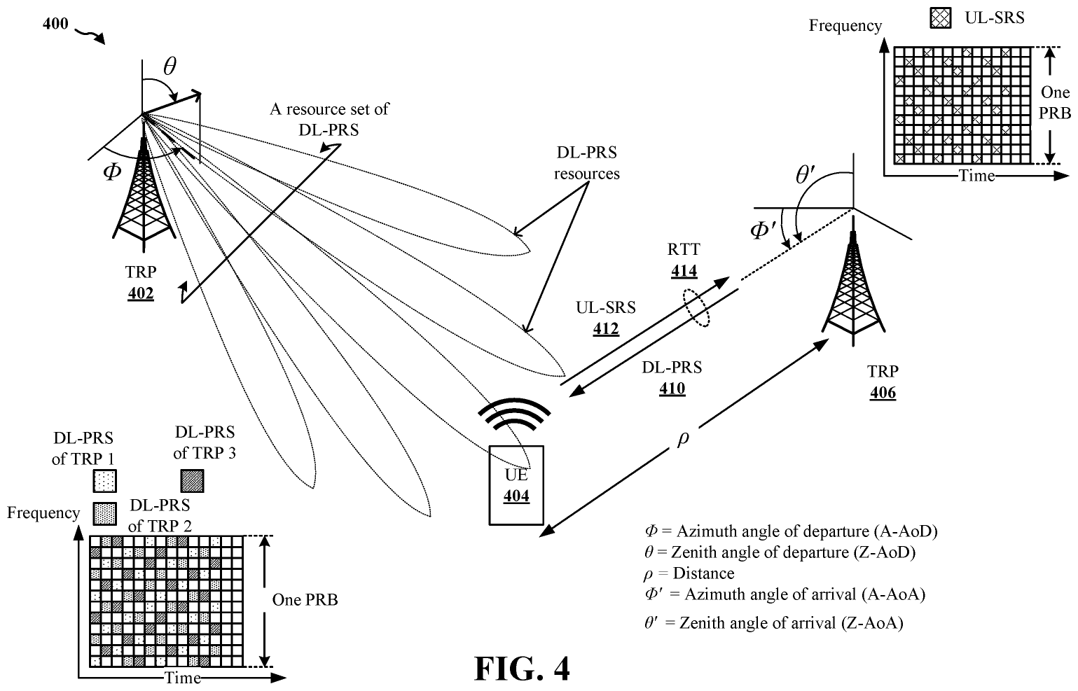

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

A wireless device (e.g., a UE, an access point (AP), a base station such as a gNB, etc.) may also be configured to include sensing capabilities, where the wireless device may be able to sense (e.g., detect and/or track) via sensing functions/operations one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

Wireless communication networks and/or a wireless devices may utilize specific waveforms for communications, such as frequency division multiplexing (OFDM, and for sensing (RF, such as FMCW signals). RF sensing operations may include scanning an area by sweeping across one or more beams. RF waveforms may be utilized for JCS or joint sensing-communications, environment scanning, object detection, weather monitoring, and/or the like. The use of RF waveforms for sensing may provide for low cost, allow flexibility, and allow the re-use of sensing waveforms for multiple purposes. Wireless communication networks may also support and enable RF-based communications between devices thereon. However, as the bandwidth allocated for wireless/cellular communications systems (e.g., in 5G NR, Enhanced 5G (5G+)) becomes larger and more use cases are introduced with wireless/cellular communications systems, joint communication/RF sensing operations (also functions) (e.g., JCS) utilization may increase further for future cellular systems (e.g., in 6G). As noted, FMCW is used in RADAR systems due to its low complexity and low cost, which may be further reused for multiple purposes, e.g., sensing, positioning, communications, JCS, etc. For sensing operations, the coexistence of multiple RADAR in congested wireless traffic may be problematic (e.g., with the increasing number of RADAR-equipped vehicles on roadways). The interference caused by other RADAR may negatively affect sensing functionality of a receiver utilizing RADAR for sensing operations, by decreasing signal detection capability. For communications, a receiver may be unable to detect a UE ID (e.g., in UL signaling) or cell ID (e.g., in DL signaling) when receiving legacy, un-coded FMCW signals transmitted by a transmitter. The received FMCW signals may also be interfered with by other FMCW transmitters.

Various aspects herein for scrambling of FMCW signals for interference mitigation in JCS in wireless communications systems improve communications and sensing in wireless communication networks and wireless devices. In one example, a first node may be configured to obtain a set of phase-coded FMCW signals, where the set of phase-coded FMCW signals is phase-coded based on a scrambling ID associated with at least one of the first node or a second node. The first node may also be configured to descramble the set of phase-coded FMCW signals based on the scrambling ID, where the set of phase-coded FMCW signals is descrambled to obtain a set of descrambled FMCW signals. The first node may also be configured to perform at least one of a sensing function, a communication function, or a joint sensing-communication function based on the set of descrambled FMCW signals. In another example, a first node may be configured to configure a set of FMCW signals. The first node may be configured to scramble the set of FMCW signals based on a scrambling ID associated with at least one of the first node or a second node, where the set of FMCW signals is scrambled to obtain a set of phase-coded FMCW signals. The first node may be configured to transmit, for the second node, the set of phase-coded FMCW signals.

The aspects herein for scrambling of FMCW signals for interference mitigation in JCS improve communications and sensing in wireless communication networks. Aspects provide for utilizing IDs at a receiver node to decode phase-coded FMCW signals to reduce interference for receivers of phase-coded FMCW signals (e.g., increase signal-to-interference ratios SIRs). Additionally, aspects provide for applying the decoding via IDs for phase-coded FMCW signals to sensing functions, communication functions, JCS or joint sensing-communication functions, and/or the like, for utilization of larger and more crowded bandwidths in 5G NR, 5G+, and for 6G operations. For instance, these signals may include desired phase-coded FMCW and un-desired phase-coded FMCW. For the desired phase-coded FMCW, the local ID at the receiver may match the phase-coded FMCW, while for the un-desired FMCW, the local ID at the receiver may not match the PC-FMCW. Aspects herein provide and enable phase-coded FMCW signal generation, transmission, and reception, receiver descrambling procedures, examples of performance evaluations for interference mitigation, signaling and procedures for sensing use cases, signaling and procedures for communication use cases, implementations for the selection of FMCW slope based on different OFDM numerology, and implementations for modulation orders of coded phase generation for FMCW signals.

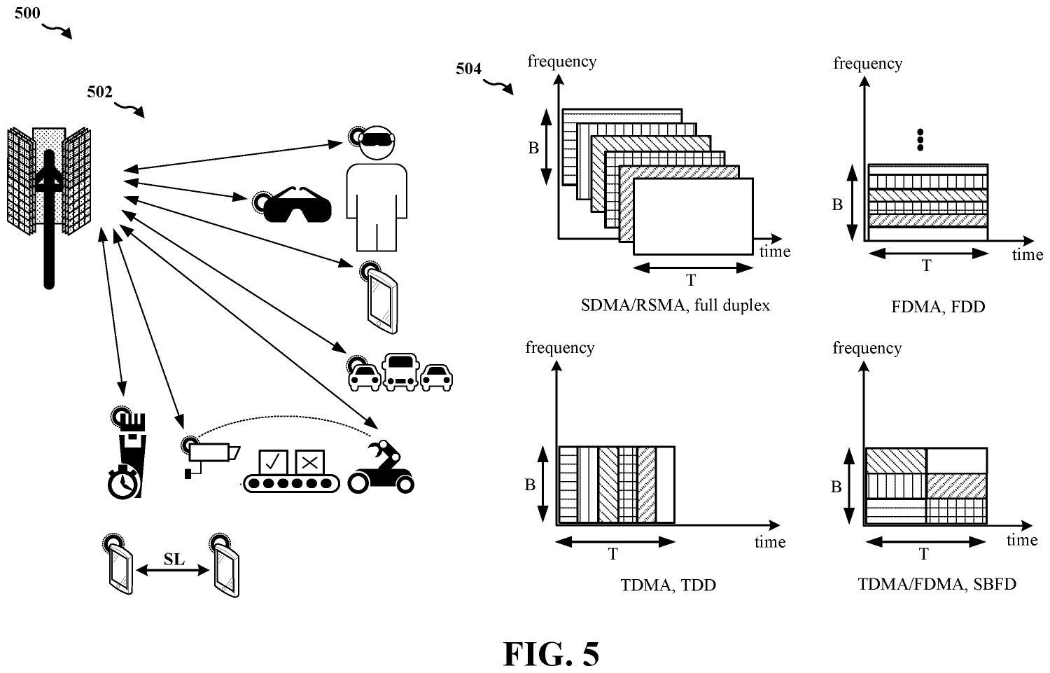

FIG. 5 is a diagram 500 illustrating examples of use cases for multiple access and waveform implementations, in various aspects. Illustrated in diagram 500 are use cases 502 and multiple access (multi-access) and waveform implementations 504.

With reference to the use cases 502, 5G NR and 5G+ may provide for different use cases for multiple access and waveform implementations, while 6G designs may provide additional use cases for multiple access and waveform implementations. By way of example and not limitation, waveform and multiple-access design in wireless communication networks may support a variety of use cases such as those illustrated in the use cases 502, including mobile broadband, metaverse, massive IoT, side-link (SL), massive spectrum aggregation/duplex, UE cooperation, manufacturing, warehouse management, wearable devices, automotive, and/or the like.

With reference to the multiple access and waveform implementations 504, multi-access/waveform designs in 5G NR and 5G+ may provide for different implementations, while 6G designs may provide additional implementations for emerging/new technologies, such as full duplex, RF sensing, positioning, PHY security, etc. 6G multi-access/waveforms designs may evolve in existing and new bands as RF/duplexing/MIMO technologies continue to advance. In the multiple access and waveform implementations 504, implementations for (1) space division multiple access (SDMA)/resource spread multiple access (RSMA), full duplex, (2) FDMA, FDD, (3) TDMA, TDD, and (4) TDMA/FDMA, sub-band full duplex (SBFD) are illustrated by way of example with respect to frequency and time. Utilization of new multi-access/waveforms may be enabled to support massive connectivity and extremely high cell-capacity based on the aspects herein. Additionally, aspects may enable efficient support of channel access for a massive numbers of users.

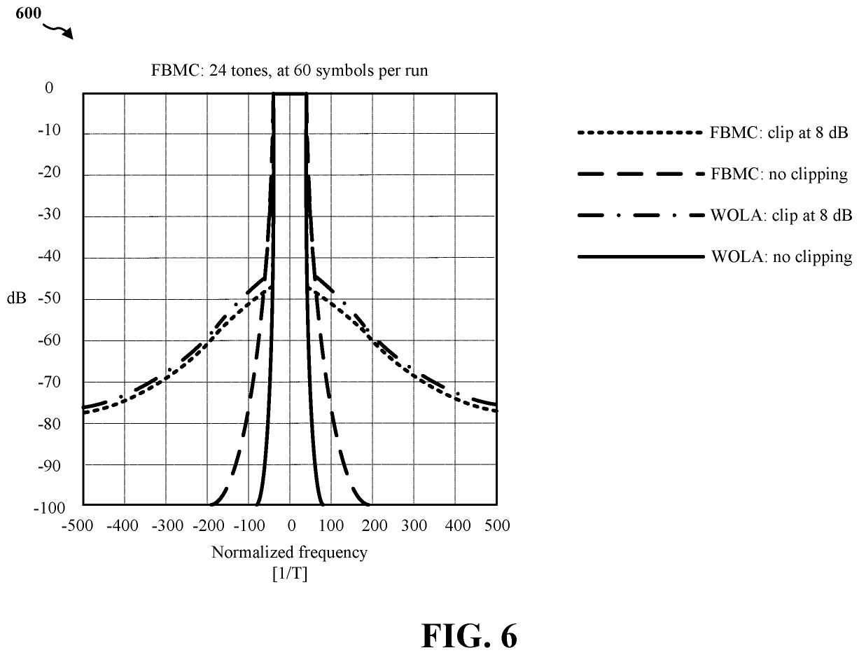

FIG. 6 is a diagram 600 illustrating examples of multiple access and waveforms, in various aspects. In diagram 600, example waveform design metrics and considerations for 5G NR are shown by way of example. For example, four plots of waveforms are shown for weighted overlap and add (WOLA) and filter bank multi-carrier (FBMC) with respect to amplitude and normalized frequency: a plot of FBMC with a clip at 8 dB, a plot of FBMC with no clipping, a plot of WOLA with a clip at 8 dB, and a plot of WOLA with no clipping. However, while WOLA and OFDM may be considered as sufficient for 5G implementations, these implementations may be insufficient for 6G implementations, such as for full duplex. Waveform design metric considerations for 5G and 6G may include, but are not limited to: spectrum efficiency, energy efficiency for Tx (e.g., power amplifier (PA) efficiency) and/or Rx (e.g., processing power efficiency), waveform processing complexity and latency, RF impairments (e.g., error vector magnitude (EVM), etc.), spectrum confinement (e.g., in-band (IB) and/or out-of-band (OOB) emissions) with practical PA models, support for efficient multi-user/MIMO multiple-access, and/or the like. Considerations against channel conditions/impairments may include, but are not limited to, fading (e.g., time variation, intersymbol interference (ISI), etc.), phase noise, PA nonlinearity, intermodal oscillation, etc.) and/or the like. Aspects herein are directed to implementations that take such waveform design metrics and considerations into account.

Additionally, aspects may account for and/or enable new alternatives to fundamental assumptions for waveform design metrics and considerations such as, but without limitation, establishing new baselines based on state-of-the-art implementations (e.g., progress in digital pre-distortion (DPD) and/or digital post-distortion (DPOD) technologies, etc.), and evaluation/implementation of design metrics in new contexts/use cases (e.g., spectrum confinement for full duplex, joint sensing and communication (JSAC) use cases, etc.). Further, aspects may account for and/or enable new alternatives for waveform candidates based on 5G deployment experience.

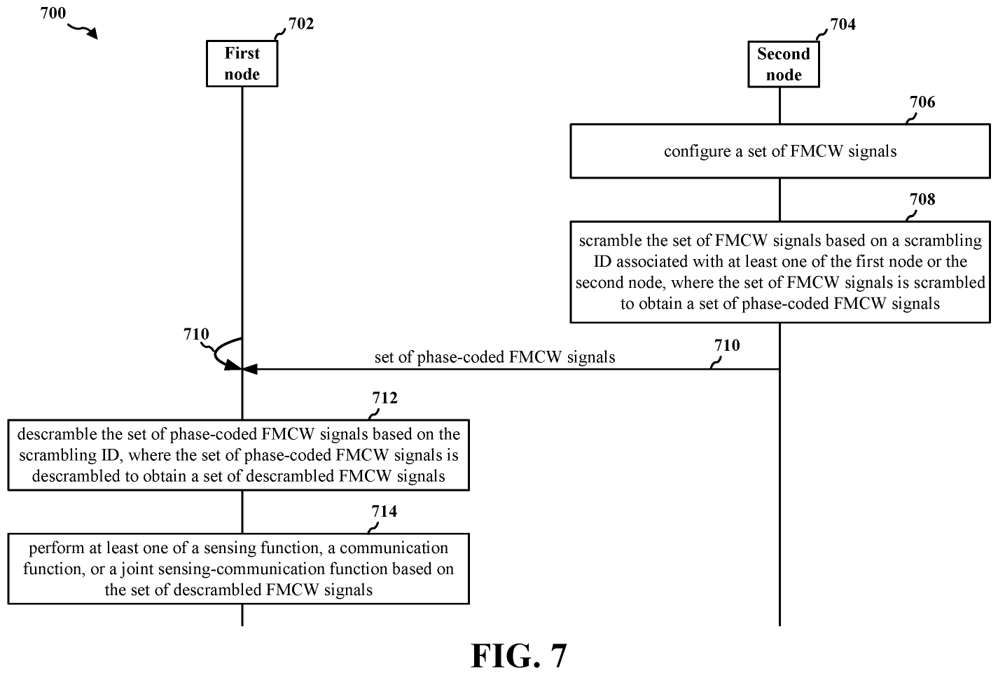

FIG. 7 is a call flow diagram 700 for wireless communications, in various aspects. Call flow diagram 700 illustrates the scrambling of FMCW signals for interference mitigation in JCS for sensing and communications by a first node (e.g., a first node 702, such as a Rx node, a UE, a sidelink (SL) UE, a TRP, a base station, a gNB, or other type of base station or network node, a network entity, etc.) that may communicate with and/or performing sensing operations with/without a second node (e.g., a second node 704, such as a Tx node, a UE, a sidelink (SL) UE, a TRP, a base station, a gNB, or other type of base station or network node, a network entity, etc.). Aspects described for the first node 702 and/or the second node 704, as a base station, may be performed by the second node 704 in aggregated form and/or by one or more components of the second node 704 in disaggregated form. Additionally, or alternatively, the aspects may be performed by the first node 702 autonomously, in addition to, and/or in lieu of, operations of the second node 704.

In the illustrated aspect, the second node 704 may be configured to configure (at 706) a set of FMCW signals. In aspects, set of FMCW signals may be configured (at 706) by the second node 704 as:

$${x}_{config} ( t ) = cos ( 2 π ( {f}_{c} + \frac{s}{2} t ) t + {ϕ}_{0} ) rect ( \frac{t - T / 2}{T} ) .$$

The second node 704 may be configured to scramble (or code) (at 708) the set of FMCW signals based on a scrambling ID associated with at least one of the first node or a second node. The set of FMCW signals may be scrambled to obtain a set of phase-coded FMCW signals (e.g., the set of phase-coded FMCW signals 710). In aspects, the phase-coded FMCW signal (e.g., one or more of the set of phase-coded FMCW signals 710) may be represented as:

$${x}_{T x} ( t ) = C ( t ) cos ( 2 π ( {f}_{c} + \frac{s}{2} t ) t + {ϕ}_{0} ) rect ( \frac{t - T / 2}{T} ) ,$$

where C(t) may represent the phase-coded waveform as:

$${\sum }_{l = 1}^{L} exp ( j {ϕ}_{l} ) rect ( \frac{t - ( l - 1 / 2 ) \cdot T / L}{T / L} ) ,$$

where L indicates that the FMCW is partitioned into L parts, and each part may be modulated with a different phase.

In aspects, a sequence (s₁, s₂, . . . sₖ) may be modulated into (ϕ₁, ϕ₂, . . . , ϕ₁, . . . , ϕ_{L}). For example, if ϕₗ∈{0, π}, then each ϕₗ represents one bit; if ϕₗ∈{0,π/2,π,3π/2}, then each ϕₗ represents two bits, etc. The sequence (s₁, s₂, . . . sₖ) may be regarded as a cell ID for DL operations, a UE ID for UL operations, or a node-specific ID for sensing operations. In aspects, rect

$$( \frac{t - X}{Y} )$$

may represent a rectangular function for a pulse centered at X with a width Y.

In aspects, the sequence (s₁, s₂, . . . sₖ) may represent a cell ID for DL or a UE ID for UL or a node-specific ID for sensing, as described herein. A transmitter node (e.g., the second node 704) may indicate to a receiver node (e.g., the first node 702) how to modulate the sequence (s₁, s₂, . . . sₖ) into (ϕ₁, ϕ₂, . . . , ϕₗ, . . . , ϕ_{L}). The receiver node may receive an indication to report its capability to the transmitter node for a maximum modulated order mₘₐₓ of the phase-coded term for the receiver node. The receiver node/the first node 702 may also receive an indication for the modulation order of the coded phase that will be utilized for phase-coded FMCW signals together with the indication of the scrambling ID, or separately with the indication of the scrambling ID. On the other hand, when a receiver node (e.g., as a network node/base station) will receive phase-coded FMCW signals (e.g., and not provide them), the receiver node may transmit/configure, for the transmitter node (e.g., a UE), a modulated order for modulating the sequence of elements (e.g., which may be based on the maximum modulated order mₘₐₓ that is reported by the UE), and receive, from the second node, the phase-coded FMCW signal(s) that are phase coded based on the coding waveform at the modulated order, where the modulated order of the coding waveform is less than or equal to the maximum modulated order capability. In aspects, when the indicated maximum modulation order is 1 (one), the receiver node may receive/obtain an indication of whether a modulation scheme is utilized as BPSK, or as π/2-BPSK, for the coded phase generation.

In some aspects, the second node 704 may be configured to transmit, for the first node 702, the set of phase-coded FMCW signals 710. In aspects, the set of phase-coded FMCW signals 710 may be transmitted to the first node 702 from the second node 704 via RF signaling. In some aspects, the first node 702 may be configured to obtain the set of phase-coded FMCW signals 710 (e.g., in configurations/operations where the first node 702 is a base station). The set of phase-coded FMCW signals 710 may be phase-coded based on a scrambling ID associated with at least one of the first node 702 or the second node 704. In aspects, the set of phase-coded FMCW signals 710 may be utilized in a sensing session (e.g., for JCS).

The first node 702 may be configured to descramble (or decode) (at 712) the set of phase-coded FMCW signals 710. In aspects, the first node 702 may be configured to descramble (at 712) the set of phase-coded FMCW signals 710 based on the scrambling ID. The scrambling ID may be received by the first node 702 from the second node 704 (e.g., in configurations for which the first node 702 is a UE), or may be obtained by the first node 702 (e.g., in configurations for which the first node 702 is a base station). The set of phase-coded FMCW signals 710 may be descrambled (at 712) to obtain a set of descrambled FMCW signals. In aspects, the first node 702 (as a receiver node) may use the scrambling ID for descrambling and/or interference mitigation.

For radar sensing purposes, the first node 702 may determine whether the received signal (e.g., the set of phase-coded FMCW signals 710) represents the desired echoes for sensing operations. For communication purposes, the first node 702 may use the cell ID or UE ID to descramble or decode the received set of phase-coded FMCW signals 710. A phase-coded FMCW (e.g., of the set of phase-coded FMCW signals 710) that is received by the first node 702 may be represented as:

$${y}_{R x} ( t ) = {\sum }_{p = 0}^{P - 1} {A}_{p} {x}_{T x} ( t - {τ}_{p} ) + n ( t ) .$$

It should be noted that C(t−τₚ) and C(t) may not match in time with each other due to the round-trip time delay τₚ. In such a case, it may not be possible to successfully decode the received signal (e.g., the set of phase-coded FMCW signals 710) by mixing the phase-coded FMCW directly, which is different from legacy un-coded FMCW reception.

In aspects, the first node 702 may be configured to perform (at 714) at least one of a sensing function, a communication function, or a joint sensing-communication function based on the set of descrambled FMCW signals (e.g., descrambled at 712). In aspects, the sensing function may be monostatic sensing, bistatic sensing (e.g., with and/or by the second node 704, a UE (not shown), and/or the like), the communication function may be UL/DL communication functions such as channel measurements and/or the like, and the joint sensing-communication function may be sensing functions and communication functions that may be performed in the same spectrum. In some aspects, the second node 704 may be configured to perform at least one of a sensing function, a communication function, or a joint sensing-communication function, as described herein.

It should be noted that a receiver node may be a network node, base station, etc., in aspects, and may still be configured to perform at least a portion of functions/operations described herein for transmitter nodes that are network node, base station, etc. For example, a base station that is a receiver node may still be configured to receive capability reports from UEs that are transmitter nodes, to configure UE transmitter nodes with a modulated order for a coding waveform, and/or the like. Additionally, any of a UE, a SL UE, a TRP, a base station, a gNB, or other type of base station or network node, a network entity, etc., may operate as either a receiver node and/or a transmitter node for different operations.

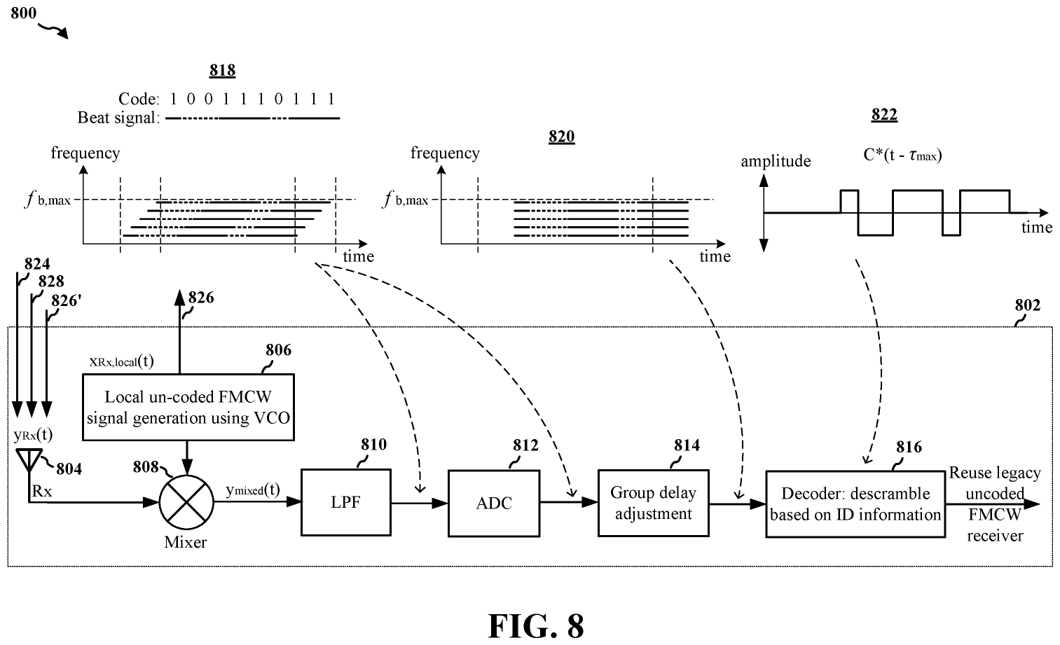

FIG. 8 is a diagram 800 illustrating an example of decoding phase-coded FMCW signals, in various aspects. Diagram 800 may be a further aspect of the call flow diagram 700 in FIG. 7 (e.g., descrambling at 712), and may be described below in such a context. Diagram 800 shows a descrambling operations performed by a receiver node 802 (e.g., the first node 702 in FIG. 7) for a set of phase-coded FMCW signals (e.g., the set of phase-coded FMCW signals 710 in FIG. 7).

For instance, a set of phase-coded FMCW signals 824, such as y_{Rx}(t), may be received by an antenna 804 of the receiver node 802 from a transmitter node (e.g., the second node 704 in FIG. 7; or from the receiver node 802 for monostatic operations, by way of example). The received set of phase-coded FMCW signals 824 may be mixed by a mixer 808 with an un-coded FMCW signal: x_{Rx,local}(t). The local un-coded FMCW signal may be generated using a voltage controlled oscillator (VCO) at the receiver node 802, and may be represented as:

$${x}_{Rx , local} ( t ) = cos ( 2 π ( {f}_{c} + \frac{s}{2} t ) t + {ϕ}_{0} ) rect ( \frac{t - T / 2}{T} ) .$$

The un-coded FMCW signal may be generated by a generator 806 of the receiver node 802 with the received set of phase-coded FMCW signals 824 to obtain a set of mixed FMCW signals: y_{mixed}(t). The receiver node 802 may also be configured to receive, from a second node, an indication 828 of the scrambling ID for at least one of the sensing function, the communication function, or the joint sensing-communication function. As noted above for FIG. 7, a receiver node (e.g., the receiver node 802) may receive an indication to report its capability to a transmitter node (e.g., the first node 702 or the second node 704 in FIG. 7) for a maximum modulation order 826 (mₘₐₓ) (also referred to as maximum modulated order) of the phase-coded term for the receiver node 802. The receiver node 802 (e.g., as a UE) may also receive an indication from the transmitter node for the modulation order 826′ of the coded phase together with the indication 828 of the scrambling ID, or separately from the indication 828 of the scrambling ID. In aspects, the receiver node 802 (e.g., as a base station) may configure the transmitter node with modulation order 826′ for the coded phase based on the maximum modulation order 826 (mₘₐₓ). The receiver node 802 may be configured to process the set of mixed FMCW signals through at least one of a low pass filter (LPF) 810 or an analog-to-digital converter (ADC) 812 to obtain a set of processed FMCW signals 818. The receiver node 802 may be configured to adjust the set of processed FMCW signals with a group delay adjustment 814 to obtain a set of aligned FMCW signals 820. The group delay adjustment 814 may be applied by the receiver node 802 to align the per-tap signals in the time-domain for different paths. For instance, in some scenarios (e.g., due to one or more properties of the received set of phase-coded FMCW signals 824), a single filter may introduce different delay adjustments for different frequency components.

The receiver node 802 may be configured to apply a descrambling waveform 822 (e.g., C*(t); also a decoding waveform) based on the scrambling ID to the set of aligned FMCW signals 820 via a decoder 816 to obtain the set of descrambled FMCW signals. As noted, the scrambling ID may be received by the receiver node 802 from a transmitter node (e.g., in configurations for which the receiver node 802 is a UE), or may be obtained by the receiver node 802 (e.g., in configurations for which the receiver node 802 is a base station). The descrambling waveform 822 may be applied after the group delay adjustment 814. C*(t), which may be a complex conjugate of C(t), may represent the descrambling waveform 822 as:

$${\sum }_{l = 1}^{L} exp ( - j {ϕ}_{l} ) rect ( \frac{t - ( l - 1 / 2 ) \cdot T / L}{T / L} ) .$$

In aspects, the baseband (e.g., of the ADC 812) value may be sufficiently low for sufficient and accurate processing shown in diagram 800. With reference to interference mitigation performance, when the receiver node 802 uses the correct ID to decode the phase-coded FMCW, the system response converges to a traditional FMCW output, the first null of which appears at

$$f = \pm \frac{1}{T} ,$$

or in terms of range ±c/2B, where the compressed pulse length is c/B. However, when the receiver node 802 uses an ID, e.g., the scrambling ID as described herein, to decode the phase-coded FMCW, then the system response is not focused and is spread through the range domain due to the phase-coded term C(t), for which the first null appears at

$$f = \pm \frac{L}{T} ,$$

or in terms of range ±cL/2B, where the compressed pulse length is cL/B.

As the signal-to-noise ratio (SNR) may be proportional to the time bandwidth product, the SIR ratio may be calculated as 10 log L. That is, the interference mitigation performance, according to the aspects herein, is better with a larger value of the coded phase length L.

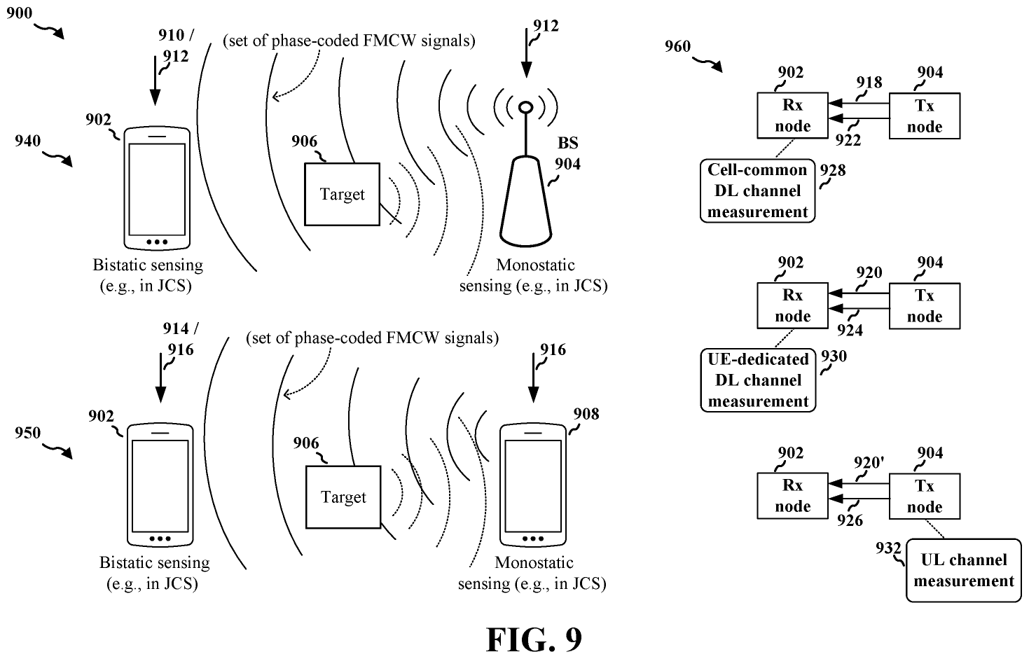

FIG. 9 is a diagram 900 illustrating examples of signaling and procedures for sensing and communications via scrambling of FMCW signals, in various aspects. A configuration 940 and a configuration 950 show signaling and procedures for sensing, and a configuration 960 shows signaling and procedures for communications. In aspects, one or more of the configuration 940, the configuration 950, and/or the configuration 960 illustrate example operations for JCS.

For example, in the configuration 940, a receiver node 902 (e.g., a first node which may be a UE) may perform bistatic sensing for JCS on a target 906 with a transmitter node 904 (e.g., a second node which may be a base station). The transmitter node 904 may transmit JCS signals to the receiver node 902, and the receiver of the receiver node 902 may estimate the target 906, while the transmitter node 904 may also detect the target 906 in the echo of the transmitted JCS signals via monostatic sensing. In aspects, the transmitter node 904 may detect the target 906 in the echo of the transmitted JCS signals via monostatic sensing without the receiver node 902 performing bistatic sensing.

In the configuration 950, the receiver node 902 may perform bistatic sensing for JCS on the target 906 with a transmitter node 908 which may also detect the target 906 in the echo of the transmitted JCS signals via monostatic sensing. In aspects, the transmitter node 908 may detect the target 906 in the echo of the transmitted JCS signals via monostatic sensing without the receiver node 902 performing bistatic sensing. It should be noted that aspects herein also contemplate that in the configuration 950 the receiver node 902 may be a base station and the transmitter node 904 may be a UE.

In aspects for monostatic sensing, each sensing node performing monostatic sensing may be configured or assigned by the transmitter node 904 a dedicated node-specific ID 912/a dedicated node-specific ID 916 (or sensing ID) for phase-coded FMCW generation and transmission. Each sensing node performing monostatic sensing may be configured to obtain, from a network node (e.g., the transmitter node 904 as a base station), an ID indication, where the ID indication indicates the scrambling ID is the node-specific ID 912/the node-specific ID 916 for the monostatic sensing. In aspects for monostatic sensing, each sensing node performing monostatic sensing may be configured to transmit the set of phase-coded FMCW signals, and to receive the set of phase-coded FMCW signals.

In some aspects for bistatic sensing (e.g., a first option), the transmitter node may be configured or assigned a dedicated node-specific ID, the node-specific ID 912/the node-specific ID 916 (or sensing ID), by a network node for phase-coded FMCW generation and transmission. The sensing node may indicate its dedicated node-specific ID (or sensing ID) during the bistatic sensing procedure/session. Each sensing node performing bistatic sensing may be configured to obtain, from a network node (e.g., the transmitter node 904 as a base station), an ID indication, where the ID indication indicates the scrambling ID is the node-specific ID 912/the node-specific ID 916 for the bistatic sensing.

In some aspects for bistatic sensing (e.g., a second option), the sensing transmitter node and the sensing receiver node may be configured or assigned a dedicated node-specific ID, a node-specific ID 910/a dedicated node-specific ID 914 (or sensing ID) by a network node (e.g., the transmitter node 904 as a base station) for phase-coded FMCW generation and transmission.

In the configuration 960, signaling and procedures for communications are illustrated for the receiver node 902 and the transmitter node 904. In the illustrated aspect, sensing functions, communication functions, and/or joint sensing-communication functions are associated with a DL channel measurement or an UL channel measurement. The receiver node 902 may be configured to obtain/receive, and the transmitter node 904 may be configured to transmit/provide, an ID indication, where the ID indication indicates the scrambling ID is at least one of a first cell ID 918 for the DL channel measurement in a cell-common operation, a first UE ID 920 for the DL channel measurement in a UE-dedicated operation, or the first UE ID 920′ for an UL channel measurement.

In aspects for a DL channel measurement (e.g., at 928 for a cell-common case), the receiver node 902 (e.g., a UE) may receive an indication 922 that the transmitter node 904 (e.g., network node/base station) may use a cell ID to generate and transmit phase-coded FMCW signals in the DL for the DL channel measurement (at 928) performed by the receiver node 902. In aspects for a DL channel measurement (e.g., at 930 for a UE-dedicated case), the receiver node 902 (e.g., a UE) may receive an indication 924 that the transmitter node 904 (e.g., network node/base station) may use UE ID to generate and transmit phase-coded FMCW signals in the DL for the DL channel measurement (at 930) performed by the receiver node 902. In aspects for a UL channel measurement (at 932), the receiver node 902 (e.g., a UE) may receive an indication 926 from the transmitter node 904 (e.g., network node/base station) to use its UE ID to generate and transmit phase-coded FMCW signals in the UL for the UL channel measurement (at 932) performed at the transmitter node 904.

In some aspects, the first cell ID 918 for the DL channel measurement in the cell-common operation may be different from a second cell ID associated with OFDM-based operations. In some aspects, the first UE ID 920 for the DL channel measurement in the UE-dedicated operation may be different from a second UE ID associated with the OFDM-based operations. In some aspects, the first UE ID 920′ for the UL channel measurement may be different from the second UE ID associated with the OFDM-based operations.

In aspects, a UE ID/cell ID for FMCW may or may not be the same as a UE ID/cell ID for OFDM based operations. An improvement may be provided by utilizing the same UE ID/cell ID for FMCW signaling and OFDM signaling, in the described aspects, may be to control signaling overhead reduction. An improvement may also be provided by utilizing different UE IDs/cell IDs for FMCW signaling and OFDM signaling, in the described aspects, may be that the length of UE IDs/cell IDs for FMCW signaling may be adaptive to the UE capability, and thus the performance of interference mitigation may be dependent on the length L, as described herein.

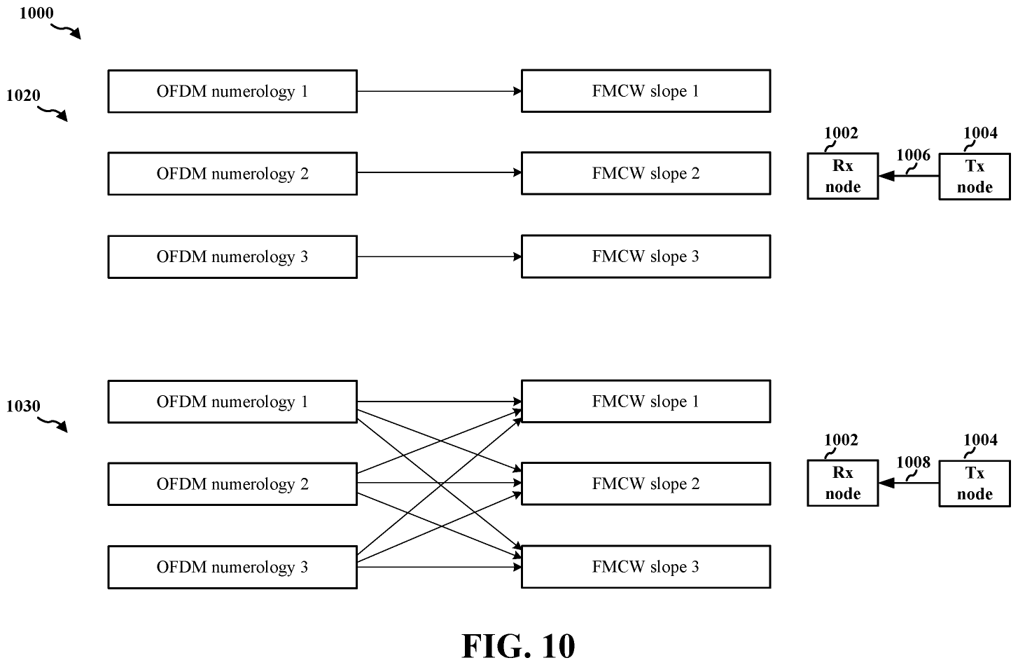

FIG. 10 is a diagram 1000 illustrating examples of FMCW slope and OFDM numerology, in various aspects. Diagram 1000 shows a configuration 1020 and a configuration 1030. Aspects herein provide that a selection of a FMCW slope may be based on configurations associated with OFDM numerology, as shown in diagram 1000.

In the configuration 1020, a single FMCW slope may be associated with each configured OFDM numerology. For instance, a single FMCW (chirp) slope may be defined for each OFDM numerology, and the receiver node 1002/the transmitter node 1004 use an associated scrambling ID 1006 for decoding without FMCW (chirp) slope information. Aspects may provide improvements based on the configuration 1030. For instance, the signaling overhead may be reduced and/or the implementation complexity may be reduced (e.g., a single FMCW (chirp) slope may be utilized).

In the configuration 1030, multiple FMCW slopes may be associated with each configured OFDM numerology. In such aspects, obtaining the set of phase-coded FMCW signals by a receiver node, as described herein, may include obtaining a FMCW slope of the multiple FMCW slopes associated with the set of phase-coded FMCW signals. In such aspects, descrambling the set of phase-coded FMCW signals by a receiver node, as described herein, may include descrambling the set of phase-coded FMCW signals further based on the FMCW slope.

That is, multiple FMCW (chirp) slopes may be supported for each OFDM numerology, and the receiver node 1002/the transmitter node 1004 may use both a FMCW (chirp) slope and an associated scrambling ID 1008 for decoding phase-coded FMCW signals. Aspects may provide improvements based on the configuration 1030.

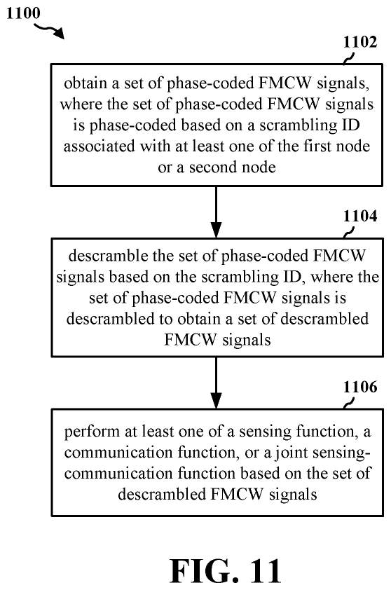

For instance, the FMCW (chirp) slope may be selected based on different scenarios for better performance, (e.g., according to a performance-complexity tradeoff). FIG. 11 is a flowchart 1100 of a method of wireless communication, in various aspects. The method may be performed by a receiver node (e.g., the base station 102; the UE 104; the first node 702; the second node 704; the receiver node 802, 902, 1002; the apparatus 1504; the network entity 1502, 1602). In some aspects, the method may include aspects described in connection with the communication flow in FIG. 7 and/or aspects described in FIGS. 5 and 8-10. The method provides for phase-coded FMCW signals for node-specific scrambling and interference mitigation that utilize an ID to decode phase-coded FMCW signals by which interference may be reduced for receivers of phase-coded FMCW signals (e.g., an increase in a SIR) for sensing functions, communication functions, JCS or joint sensing-communication functions, and/or the like.

At 1102, a receiver node obtains a set of phase-coded FMCW signals, where the set of phase-coded FMCW signals is phase-coded based on a scrambling ID associated with at least one of the first node or a second node. As an example, the obtaining may be performed, at least in part, by the component 198. FIGS. 7, 8 illustrate an example of the receiver node (e.g., the first node 702) obtaining such a set of phase-coded FMCW signals from a transmitter node (e.g., the second node 704) or the first node 702.

The second node 704 may be configured to transmit, for the first node 702, the set of phase-coded FMCW signals 710 (e.g., in configurations/operations where the second node 704 is a base station). In aspects, the set of phase-coded FMCW signals 710 may be transmitted to the first node 702 from the second node 704 via RF signaling. In some aspects, the first node 702 may be configured to obtain the set of phase-coded FMCW signals 710 (e.g., in configurations/operations where the first node 702 is a UE). The set of phase-coded FMCW signals 710 may be phase-coded based on a scrambling ID associated with at least one of the first node 702 or the second node 704. In aspects, the set of phase-coded FMCW signals 710 may be utilized in a sensing session (e.g., for JCS).

At 1104, the receiver node descrambles the set of phase-coded FMCW signals based on the scrambling ID, where the set of phase-coded FMCW signals is descrambled to obtain a set of descrambled FMCW signals. As an example, the descrambling may be performed, at least in part, by the component 198. FIGS. 7, 8 illustrate an example of the first node 702 descrambling such a set of phase-coded FMCW signals based on a scrambling ID.

The first node 702 may be configured to descramble (or decode) (at 712) the set of phase-coded FMCW signals 710. In aspects, the first node 702 may be configured to descramble (at 712) the set of phase-coded FMCW signals 710 based on the scrambling ID. The scrambling ID may be received by the first node 702 from the second node 704 (e.g., in configurations for which the first node 702 is a UE), or may be obtained by the first node 702 (e.g., in configurations for which the first node 702 is a base station). The set of phase-coded FMCW signals 710 may be descrambled (at 712) to obtain a set of descrambled FMCW signals. In aspects, the first node 702 (as a receiver node) may use the scrambling ID for descrambling and/or interference mitigation.

At 1106, the receiver node performs at least one of a sensing function, a communication function, or a joint sensing-communication function based on the set of descrambled FMCW signals. As an example, the performance may be performed, at least in part, by the component 198. FIGS. 7, 9 illustrate an example of the first node 702 performing such functions.

The first node 702 may be configured to perform (at 714) at least one of a sensing function, a communication function, or a joint sensing-communication function based on the set of descrambled FMCW signals (e.g., descrambled at 712). In aspects, the sensing function may be monostatic sensing, bistatic sensing (e.g., with the second node 704, a UE (not shown), and/or the like), the communication function may be UL/DL communication functions such as channel measurements and/or the like, and the joint sensing-communication function may be sensing functions and communication functions that may be performed in the same spectrum.

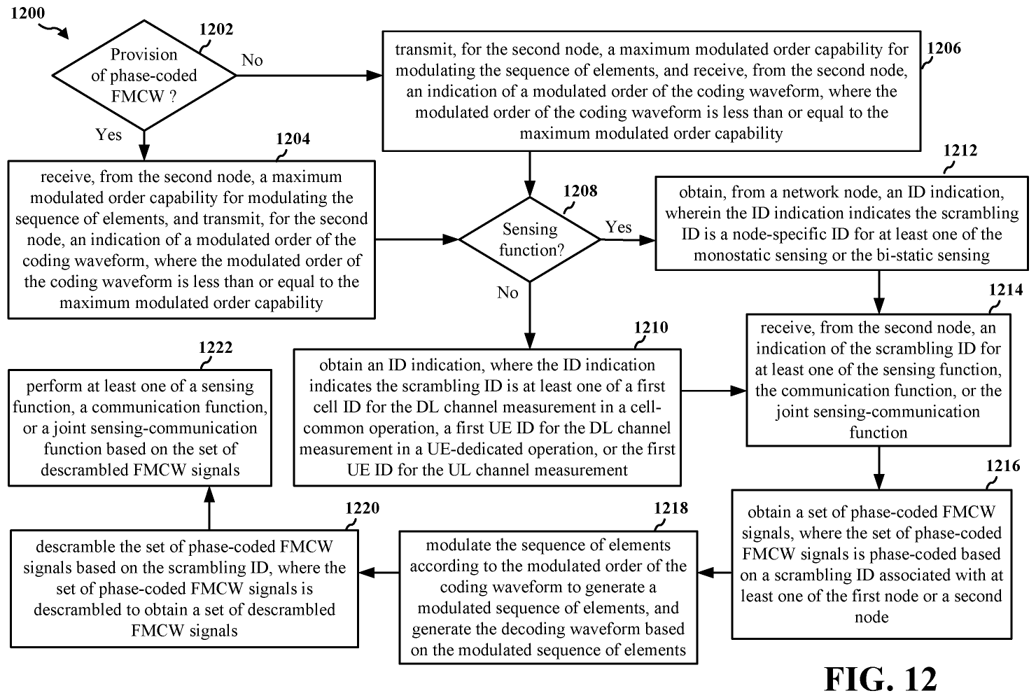

FIG. 12 is a flowchart 1200 of a method of wireless communication, in various aspects. The method may be performed by a receiver node (e.g., the base station 102; the UE 104; the first node 702; the second node 704; the receiver node 802, 902, 1002; the apparatus 1504; the network entity 1502, 1602). In some aspects, the method may include aspects described in connection with the communication flow in FIG. 7 and/or aspects described in FIGS. 5 and 8-10. The method provides for phase-coded FMCW signals for node-specific scrambling and interference mitigation that utilize an ID to decode phase-coded FMCW signals by which interference may be reduced for receivers of phase-coded FMCW signals (e.g., an increase in a SIR) for sensing functions, communication functions, JCS or joint sensing-communication functions, and/or the like.

At 1202, a receiver node determines if it will provide a set of phase-coded FMCW signals or not for a sensing function, a communication function, or a joint sensing-communication function. If a set of phase-coded FMCW signals will be provided, flowchart 1200 may continue to 1204; if not, flowchart 1200 may continue to 1206. As an example, the determination may be performed, at least in part, by the component 198.

At 1204, the receiver node receives, from the second node, a maximum modulated order capability for modulating the sequence of elements, and/or transmits, for the second node, an indication of a modulated order of the coding waveform, where the modulated order of the coding waveform is less than or equal to the maximum modulated order capability. As an example, the reception and/or transmission may be performed, at least in part, by the component 198. FIGS. 7, 8 illustrate an example of a receiver node (e.g., the first node 702, the receiver node 802) receiving and/or transmitting for the maximum modulated order with a transmitter node (e.g., the second node 704).

When the receiver node 802 does provide a set of phase-coded FMCW signals for a sensing function, a communication function, or a joint sensing-communication function, as noted above for FIG. 7, a receiver node (e.g., the receiver node 802) may receive an indication to report its capability to a transmitter node (e.g., the first node 702 or the second node 704 in FIG. 7) for a maximum modulation order 826 (mₘₐₓ) of the phase-coded term for the receiver node 802. The receiver node 802 may also receive an indication from the transmitter node for the maximum modulation order 826 of the coded phase together with the indication of the scrambling ID, or separately with the indication of the scrambling ID.

At 1206, the receiver node transmits, for the second node, a maximum modulated order capability for modulating the sequence of elements, and receive, from the second node, an indication of a modulated order of the coding waveform, where the modulated order of the coding waveform is less than or equal to the maximum modulated order capability. As an example, the transmission and/or reception may be performed, at least in part, by the component 198. FIGS. 7, 8 illustrate an example of a receiver node (e.g., the first node 702, the receiver node 802) transmitting and/or receiving for the maximum modulated order with a transmitter node (e.g., the second node 704).

When the receiver node (e.g., the first node 702) does not provide a set of phase-coded FMCW signals for a sensing function, a communication function, or a joint sensing-communication function, as noted above for FIG. 7, e.g., when a receiver node (e.g., as a network node/base station) will receive phase-coded FMCW signals and not provide them, the receiver node may transmit, for the transmitter node (e.g., a UE), a maximum modulated order capability for modulating the sequence of elements, and receive, from the second node, an indication of a modulated order of the coding waveform, where the modulated order of the coding waveform is less than or equal to the maximum modulated order capability. A receiver node (e.g., the receiver node 802) may receive an indication to report its capability to a transmitter node (e.g., the first node 702 or the second node 704 in FIG. 7) for a maximum modulation order 826 (mₘₐₓ) of the phase-coded term for the receiver node 802. The receiver node 802 may also receive an indication from the transmitter node for the maximum modulation order 826 of the coded phase together with the indication of the scrambling ID, or separately with the indication of the scrambling ID.

At 1208, the receiver node determines if a sensing function will be performed. If a sensing function will not be performed, flowchart 1200 may continue to 1210; if a sensing function will be performed, flowchart 1200 may continue to 1212. As an example, the determination may be performed, at least in part, by the component 198.

At 1210, the receiver node obtains an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. As an example, the obtaining may be performed, at least in part, by the component 198. FIGS. 7, 9 illustrate an example of a receiver node (e.g., the first node 702, the receiver node 902) obtaining an ID indication with a scrambling ID from a transmitter node (e.g., the second node 704, the transmitter node 904).

The receiver node 902 may be configured to obtain/receive, and the transmitter node 904 may be configured to transmit/provide, an ID indication, where the ID indication indicates the scrambling ID is at least one of a first cell ID 918 for the DL channel measurement in a cell-common operation, a first UE ID 920 for the DL channel measurement in a UE-dedicated operation, or the first UE ID 920′ for an UL channel measurement.

In aspects for a DL channel measurement (e.g., at 928 for a cell-common case), the receiver node 902 (e.g., a UE) may receive an indication 922 that the transmitter node 904 (e.g., network node/base station) may use a cell ID to generate and transmit phase-coded FMCW signals in the DL for the DL channel measurement (at 928) performed by the receiver node 902. In aspects for a DL channel measurement (e.g., at 930 for a UE-dedicated case), the receiver node 902 (e.g., a UE) may receive an indication 924 that the transmitter node 904 (e.g., network node/base station) may use UE ID to generate and transmit phase-coded FMCW signals in the DL for the DL channel measurement (at 930) performed by the receiver node 902. In aspects for a UL channel measurement (at 932), the receiver node 902 (e.g., a UE) may receive an indication 926 from the transmitter node 904 (e.g., network node/base station) to use its UE ID to generate and transmit phase-coded FMCW signals in the UL for the UL channel measurement (at 932) performed at the transmitter node 904.

At 1212, the receiver node obtains, from a network node, an ID indication, where the ID indication indicates the scrambling ID is a node-specific ID for at least one of the monostatic sensing or the bi-static sensing. As an example, the obtaining may be performed, at least in part, by the component 198. FIGS. 7, 9 illustrate an example of a receiver node (e.g., the first node 702, the receiver node 902) obtaining an ID indication with a scrambling ID from a transmitter node (e.g., the second node 704, the transmitter node 904).

In the configuration 940, a receiver node 902 (e.g., a first node which may be a UE) may perform bistatic sensing for JCS on a target 906 with a transmitter node 904 (e.g., a second node which may be a base station). The transmitter node 904 may transmit JCS signals to the receiver node 902, and the receiver of the receiver node 902 may estimate the target 906, while the transmitter node 904 may also detect the target 906 in the echo of the transmitted JCS signals via monostatic sensing. In aspects, the transmitter node 904 may detect the target 906 in the echo of the transmitted JCS signals via monostatic sensing without the receiver node 902 performing bistatic sensing.

In the configuration 950, the receiver node 902 may perform bistatic sensing for JCS on the target 906 with a transmitter node 908 which may also detect the target 906 in the echo of the transmitted JCS signals via monostatic sensing. In aspects, the transmitter node 908 may detect the target 906 in the echo of the transmitted JCS signals via monostatic sensing without the receiver node 902 performing bistatic sensing. It should be noted that aspects herein also contemplate that in the configuration 950 the receiver node 902 may be a base station and the transmitter node 904 may be a UE. In aspects for monostatic sensing, each sensing node performing monostatic sensing may be configured or assigned by the transmitter node 904 a dedicated node-specific ID 912/a dedicated node-specific ID 916 (or sensing ID) for phase-coded FMCW generation and transmission. Each sensing node performing monostatic sensing may be configured to obtain, from a network node (e.g., the transmitter node 904 as a base station), an ID indication, where the ID indication indicates the scrambling ID is the node-specific ID 912/the node-specific ID 916 for the monostatic sensing. In aspects for monostatic sensing, each sensing node performing monostatic sensing may be configured to transmit the set of phase-coded FMCW signals, and to receive the set of phase-coded FMCW signals. In some aspects for bistatic sensing (e.g., a first option), the transmitter node may be configured or assigned a dedicated node-specific ID, the node-specific ID 912/the node-specific ID 916 (or sensing ID), by a network node for phase-coded FMCW generation and transmission. The sensing node may indicate its dedicated node-specific ID (or sensing ID) during the bistatic sensing procedure/session. Each sensing node performing bistatic sensing may be configured to obtain, from a network node (e.g., the transmitter node 904 as a base station), an ID indication, where the ID indication indicates the scrambling ID is the node-specific ID 912/the node-specific ID 916 for the bistatic sensing. In some aspects for bistatic sensing (e.g., a second option), the sensing transmitter node and the sensing receiver node may be configured or assigned a dedicated node-specific ID, a node-specific ID 910/a dedicated node-specific ID 914 (or sensing ID) by a network node (e.g., the transmitter node 904 as a base station) for phase-coded FMCW generation and transmission.

At 1214, the receiver node receives, from the second/transmit node, an indication of the scrambling ID for at least one of the sensing function, the communication function, or the joint sensing-communication function. As an example, the reception may be performed, at least in part, by the component 198. FIGS. 7, 8, 9 illustrate an example of such a reception by a receiver node (e.g., the first node 702, the receiver node 902) from a transmitter node (e.g., the second node 704, the transmitter node 904).

For example, the receiver node 802 may also be configured to receive, from a second node, an indication 828 of the scrambling ID for at least one of the sensing function, the communication function, or the joint sensing-communication function. As noted above for obtaining the ID indication at 1210/1212, the scrambling ID indicated to the receiver node 902 from the transmitter node 904 may be accompanied by an indication of the type of function with which it is associated: a sensing function, a communication function, or a joint sensing-communication function.

At 1216, the receiver node obtains a set of phase-coded FMCW signals, where the set of phase-coded FMCW signals is phase-coded based on a scrambling ID associated with at least one of the first node or a second node. As an example, the obtaining may be performed, at least in part, by the component 198. FIGS. 7, 8 illustrate an example of the receiver node (e.g., the first node 702) obtaining such a set of phase-coded FMCW signals from a transmitter node (e.g., the second node 704) or the first node 702.

The second node 704 may be configured to transmit, for the first node 702, the set of phase-coded FMCW signals 710 (e.g., in configurations/operations where the second node 704 is a base station). In aspects, the set of phase-coded FMCW signals 710 may be transmitted to the first node 702 from the second node 704 via RF signaling. In some aspects, the first node 702 may be configured to obtain the set of phase-coded FMCW signals 710 (e.g., in configurations/operations where the first node 702 is a UE). The set of phase-coded FMCW signals 710 may be phase-coded based on a scrambling ID associated with at least one of the first node 702 or the second node 704. In aspects, the set of phase-coded FMCW signals 710 may be utilized in a sensing session (e.g., for JCS).

At 1218, the receiver node modulates the sequence of elements according to the modulated order of the coding waveform to generate a modulated sequence of elements, and generate the decoding waveform based on the modulated sequence of elements. As an example, the modulation/generation may be performed, at least in part, by the component 198. FIGS. 7, 8 illustrate an example of the first node 702 performing such a modulation and generation.

The second node 704 may be configured to scramble (or code) (at 708) the set of FMCW signals based on a scrambling ID associated with at least one of the first node or a second node. The set of FMCW signals may be scrambled to obtain a set of phase-coded FMCW signals (e.g., the set of phase-coded FMCW signals 710). In aspects, the phase-coded FMCW signal (e.g., one or more of the set of phase-coded FMCW signals 710) may be represented as:

$${x}_{T x} ( t ) = C ( t ) cos ( 2 π ( {f}_{c} + \frac{s}{2} t ) t + {ϕ}_{0} ) rect ( \frac{t - T / 2}{T} ) ,$$

where C(t) may represent the phase-coded waveform as:

$${\sum }_{l = 1}^{L} exp ( - j {ϕ}_{l} ) rect ( \frac{t - ( l - 1 / 2 ) \cdot T / L}{T / L} ) ,$$

where L indicates that the FMCW is partitioned into L parts, and each part may be modulated with a different phase.

In aspects, a sequence (s₁, s₂, . . . sₖ) may be modulated into (ϕ₁, ϕ₂, . . . , ϕₗ, . . . , ϕ_{L}). For example, if ϕₗ∈{0,π}, then each ϕₗ represents one bit; if ϕₗ∈{0,π/2,π,3π/2}, then each ϕₗ represents two bits, etc. The sequence (s₁, s₂, . . . sₖ) may be regarded as a cell ID for DL operations, a UE ID for UL operations, or a node-specific ID for sensing operations. In aspects, rect

$$( \frac{t - X}{Y} )$$

may represent a rectangular function for a pulse centered at X with a width Y.

In aspects, the sequence (s₁, s₂, . . . sₖ) may represent a cell ID for DL or a UE ID for UL or a node-specific ID for sensing, as described herein. A transmitter node (e.g., the second node 704) may indicate to a receiver node (e.g., the first node 702) how to modulate the sequence (s₁, s₂, . . . sₖ) into (ϕ₁, ϕ₂, . . . , ϕₗ, . . . , ϕ_{L}). The receiver node may receive an indication to report its capability to the transmitter node for a maximum modulation order 826 mₘₐₓ of the phase-coded term for the receiver node. The receiver node may also receive an indication for the maximum modulation order 826 of the coded phase together with the indication of the scrambling ID, or separately with the indication of the scrambling ID. On the other hand, when a receiver node (e.g., as a network node/base station) will receive phase-coded FMCW signals and not provide them, the receiver node may transmit, for the transmitter node (e.g., a UE, a maximum modulated order capability for modulating the sequence of elements, and receive, from the second node, an indication of a modulated order of the coding waveform, where the modulated order of the coding waveform is less than or equal to the maximum modulated order capability. In aspects, when the indicated maximum modulation order 826 is 1 (one), the receiver node may receive/obtain an indication of whether a modulation scheme is utilized as BPSK, or as π/2-BPSK, for the coded phase generation.

At 1220, the receiver node descrambles the set of phase-coded FMCW signals based on the scrambling ID, where the set of phase-coded FMCW signals is descrambled to obtain a set of descrambled FMCW signals. As an example, the descrambling may be performed, at least in part, by the component 198. FIGS. 7, 8 illustrate an example of the first node 702 descrambling such a set of phase-coded FMCW signals based on a scrambling ID.

The first node 702 may be configured to descramble (or decode) (at 712) the set of phase-coded FMCW signals 710. In aspects, the first node 702 may be configured to descramble (at 712) the set of phase-coded FMCW signals 710 based on the scrambling ID. The scrambling ID may be received by the first node 702 from the second node 704 (e.g., in configurations for which the first node 702 is a UE), or may be obtained by the first node 702 (e.g., in configurations for which the first node 702 is a base station). The set of phase-coded FMCW signals 710 may be descrambled (at 712) to obtain a set of descrambled FMCW signals. In aspects, the first node 702 (as a receiver node) may use the scrambling ID for descrambling and/or interference mitigation.

At 1222, the receiver node performs at least one of a sensing function, a communication function, or a joint sensing-communication function based on the set of descrambled FMCW signals. As an example, the performance may be performed, at least in part, by the component 198. FIGS. 7, 9 illustrate an example of the first node 702 performing such functions.

The first node 702 may be configured to perform (at 714) at least one of a sensing function, a communication function, or a joint sensing-communication function based on the set of descrambled FMCW signals (e.g., descrambled at 712). In aspects, the sensing function may be monostatic sensing, bistatic sensing (e.g., with the second node 704, a UE (not shown), and/or the like), the communication function may be UL/DL communication functions such as channel measurements and/or the like, and the joint sensing-communication function may be sensing functions and communication functions that may be performed in the same spectrum.

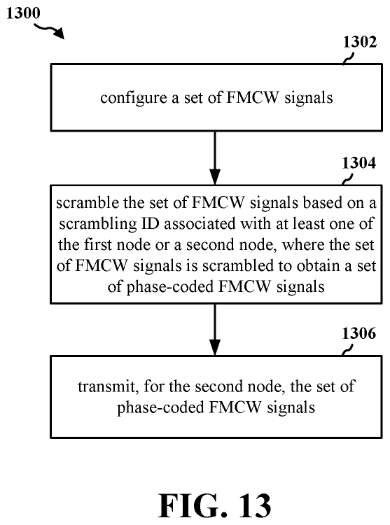

FIG. 13 is a flowchart 1300 of a method of wireless communication, in various aspects. The method may be performed by a transmitter node (e.g., the base station 102; the UE 104; the first node 702; the second node 704; the receiver node 802, 902, 1002; the transmitter node 904, 1004; the apparatus 1504; the network entity 1502, 1602). In some aspects, the method may include aspects described in connection with the communication flow in FIG. 7 and/or aspects described in FIGS. 5 and 8-10. The method provides for phase-coded FMCW signals for node-specific scrambling and interference mitigation that utilize an ID to decode phase-coded FMCW signals by which interference may be reduced for receivers of phase-coded FMCW signals (e.g., an increase in a signal-to-interference ratio (SIR)) for sensing functions, communication functions, JCS or joint sensing-communication functions, and/or the like.

At 1302, a transmitter node configures a set of FMCW signals. As an example, the configuration may be performed, at least in part, by the component 199. FIGS. 6-9 illustrate an example of a transmitter node (e.g., the second node 704) configuring such a set of FMCW signals.

The second node 704 may be configured to configure (at 706) a set of FMCW signals. In aspects, set of FMCW signals may be configured (at 706) by the second node 704 as:

$${x}_{config} ( t ) = cos ( 2 π ( {f}_{c} + \frac{s}{2} t ) t + {ϕ}_{0} ) rect ( \frac{t - T / 2}{T} ) .$$

The second node 704 may be configured to scramble (or code) (at 708) the set of FMCW signals based on a scrambling ID associated with at least one of the first node or a second node.

At 1304, a transmitter node scrambles the set of FMCW signals based on a scrambling ID associated with at least one of the first node or a second node, where the set of FMCW signals is scrambled to obtain a set of phase-coded FMCW signals. As an example, the scrambling may be performed, at least in part, by the component 199. FIG. 7 illustrates an example of a transmitter node (e.g., the second node 704) scrambling such a set of FMCW signals to obtain a set of phase-coded FMCW signals.

The second node 704 may scramble the set of FMCW signals to obtain a set of phase-coded FMCW signals (e.g., the set of phase-coded FMCW signals 710). In aspects, the phase-coded FMCW signal (e.g., one or more of the set of phase-coded FMCW signals 710) may be represented as:

$${x}_{Tx} ( t ) = C ( t ) cos ( 2 π ( {f}_{c} + \frac{s}{2} t ) t + {ϕ}_{0} ) rect ( \frac{t - T / 2}{T} ) ,$$

where C(t) may represent the phase-coded waveform as:

$${\sum }_{l = 1}^{L} exp ( - j {ϕ}_{l} ) rect ( \frac{t - ( l - 1 / 2 ) \cdot T / L}{T / L} ) ,$$

where L indicates that the FMCW is partitioned into L parts, and each part may be modulated with a different phase.

In aspects, a sequence (s₁, s₂, . . . sₖ) may be modulated into (ϕ₁, ϕ₂, . . . , ϕₗ, . . . , ϕ_{L}). For example, if ϕₗ∈{0, π}, then each ϕₗ represents one bit; if ϕ₁∈{0,π/2,π,3π/2}, then each ϕₗ represents two bits, etc. The sequence (s₁, s₂, . . . sₖ) may be regarded as a cell ID for DL operations, a UE ID for UL operations, or a node-specific ID for sensing operations. In aspects, rect

$$( \frac{t - X}{Y} )$$

may represent a rectangular function for a pulse centered at X with a width Y.

In aspects, the sequence (s₁, s₂, . . . sₖ) may represent a cell ID for DL or a UE ID for UL or a node-specific ID for sensing, as described herein. A transmitter node (e.g., the second node 704) indicate to a receiver node (e.g., the first node 702) how to modulate the sequence (s₁, s₂, . . . s_{K}) into (ϕ₁, ϕ₂, . . . , ϕₗ, . . . , ϕ_{L}). The receiver node may receive an indication to report its capability to the transmitter node for the maximum modulated order mₘₐₓ of the phase-coded term for the receiver node. The receiver node may also receive an indication for the modulation order of the coded phase together with the indication of the scrambling ID, or separately with the indication of the scrambling ID. In aspects, when the indicated modulation order is 1 (one), the receiver node may receive/obtain an indication of whether a modulation scheme is utilized as BPSK, or as π/2-BPSK, for the coded phase generation.

At 1306, the transmitter node transmits, for the second node, the set of phase-coded FMCW signals. As an example, the transmission may be performed, at least in part, by the component 199. FIG. 7 illustrates an example of a transmitter node (e.g., the second node 704) transmitting such a set of phase-coded FMCW signals.

The second node 704 may be configured to transmit, for the first node 702, the set of phase-coded FMCW signals 710. In aspects, the set of phase-coded FMCW signals 710 may be transmitted to the first node 702 from the second node 704 via RF signaling. In some aspects, the first node 702 may be configured to obtain the set of phase-coded FMCW signals 710 (e.g., in configurations/operations where the first node 702 is a base station). The set of phase-coded FMCW signals 710 may be phase-coded based on a scrambling ID associated with at least one of the first node 702 or the second node 704. In aspects, the set of phase-coded FMCW signals 710 may be utilized in a sensing session (e.g., for JCS).

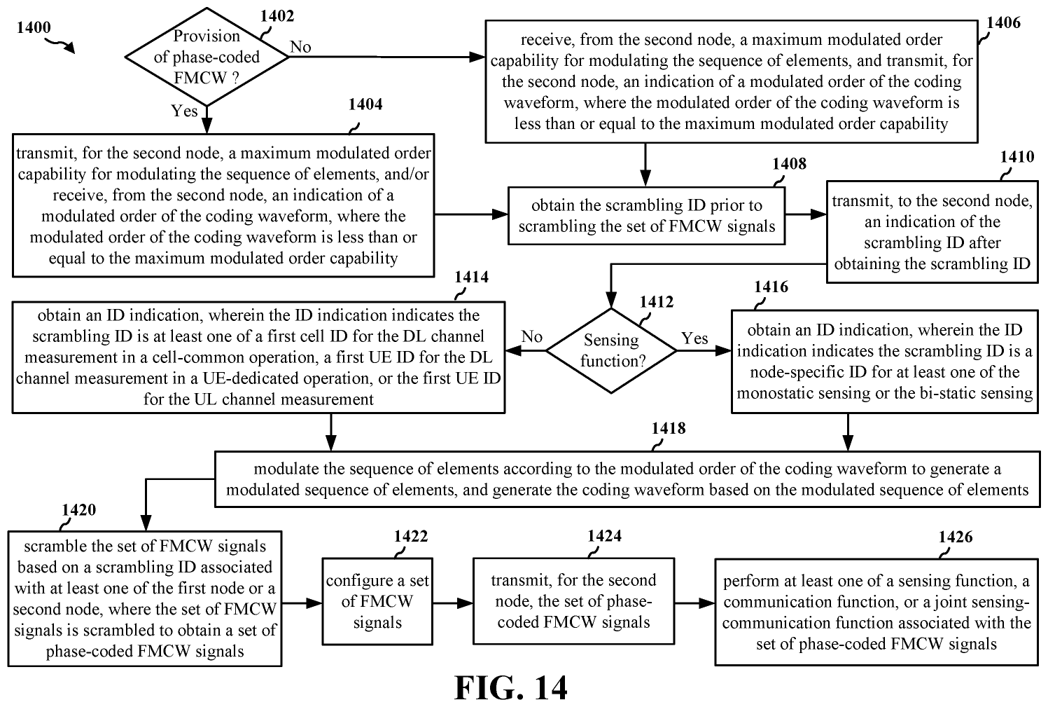

FIG. 14 is a flowchart 1400 of a method of wireless communication, in various aspects. The method may be performed by a transmitter node (e.g., the base station 102; the UE 104; the first node 702; the second node 704; the transmitter node 904, 1004; the apparatus 1504; the network entity 1502, 1602). In some aspects, the method may include aspects described in connection with the communication flow in FIG. 7 and/or aspects described in FIGS. 5 and 8-10. The method provides for phase-coded FMCW signals for node-specific scrambling and interference mitigation that utilize an ID to decode phase-coded FMCW signals by which interference may be reduced for receivers of phase-coded FMCW signals (e.g., an increase in a signal-to-interference ratio (SIR)) for sensing functions, communication functions, JCS or joint sensing-communication functions, and/or the like.

At 1402, a transmitter node determines if it will provide a set of phase-coded FMCW signals or not for a sensing function, a communication function, or a joint sensing-communication function. If a set of phase-coded FMCW signals will be provided, flowchart 1400 may continue to 1404; if not, flowchart 1400 may continue to 1406. As an example, the determination may be performed, at least in part, by the component 199.

At 1404, the transmitter node transmits, for the second node, a maximum modulated order capability for modulating the sequence of elements, and/or receives, from the second node, an indication of a modulated order of the coding waveform, where the modulated order of the coding waveform is less than or equal to the maximum modulated order capability. As an example, the transmission and/or reception may be performed, at least in part, by the component 199. FIGS. 7, 8 illustrate an example of a transmitter node (e.g., the second node 704, a transmitter node in FIG. 8) transmitting and/or receiving for the maximum modulation order with a receiver node (e.g., the first node 702, the receiver node 802).

When the second node 704 does provide a set of phase-coded FMCW signals for a sensing function, a communication function, or a joint sensing-communication function, as inversely noted above for FIG. 7 for a receiver node (e.g., the receiver node 802), the second node 704/transmitter node may transmit an indication to report its capability to a receiver node (e.g., the first node 702 in FIG. 7; the receiver node 802 in FIG. 8) for a maximum modulation order 826 (mₘₐₓ) of the phase-coded term for the receiver node 802. The transmitter node (e.g., the second node 704) may also transmit an indication for the receiver node for the maximum modulation order 826 of the coded phase together with the indication of the scrambling ID, or separately with the indication of the scrambling ID.

At 1406, the transmitter node receives, from the second node, a maximum modulated order capability for modulating the sequence of elements, and transmit, for the second node, an indication of a modulated order of the coding waveform, where the modulated order of the coding waveform is less than or equal to the maximum modulated order capability. As an example, the reception and/or transmission may be performed, at least in part, by the component 199. FIGS. 7, 8 illustrate an example of a transmitter node (e.g., the second node 704) receiving and/or transmitting for the maximum modulation order with a receiver node (e.g., the first node 702, the receiver node 802).

When the transmitter node/the second node 704 does not provide a set of phase-coded FMCW signals for a sensing function, a communication function, or a joint sensing-communication function, as noted above for FIG. 7, e.g., when a transmitter node (e.g., as a network node/base station) will receive phase-coded FMCW signals and not provide them, the transmitter node may receive, from the first node 702/the receiver node 802 (e.g., a UE), a maximum modulated order capability for modulating the sequence of elements, and transmit, for the second node, an indication of a modulated order of the coding waveform, where the modulated order of the coding waveform is less than or equal to the maximum modulated order capability. A transmitter node (e.g., the second node 704) may transmit an indication to report its capability to a receiver node (e.g., the first node 702 in FIG. 7; the receiver node 802 in FIG. 8) for a maximum modulation order 826 (mₘₐₓ) of the phase-coded term for the first node 702/the receiver node 802. The transmitter node/the second node 704 may also transmit an indication for the first node 702/the receiver node 802 for the maximum modulation order 826 of the coded phase together with the indication of the scrambling ID, or separately with the indication of the scrambling ID.

At 1408, the transmitter node obtains the scrambling ID prior to scrambling the set of FMCW signals. As an example, the obtaining may be performed, at least in part, by the component 199. FIGS. 7, 8 illustrate an example of a transmitter node (e.g., the second node 704) receiving and/or transmitting for the maximum modulation order with a receiver node (e.g., the first node 702, the receiver node 802).

In aspects, the scrambling ID may be configured for receiver nodes by the transmit node/second node 704 (e.g., as a network node/base station for UEs as receiver nodes). Accordingly, the transmit node/second node 704 may obtain the scrambling ID prior to scrambling the set of FMCW signals. In other aspects, the transmit node/second node 704 may be configured to receive an indication of the scrambling ID from a network node/base station prior to scrambling the set of FMCW signals.

At 1410, the transmitter node transmits, to the second node, an indication of the scrambling ID based on the obtained scrambling ID. As an example, the determination may be performed, at least in part, by the component 199. FIGS. 7, 8, 9, 10 illustrate an example of such a transmission by a transmitter node (e.g., the second node 704, the transmitter node 904) of an indication for a receiver node (e.g., the first node 702, the receiver node 902).

For example, the receiver node 802 may also be configured to receive, from the second node (e.g., a transmitter node; the second node 704; the transmitter node 904), an indication of the scrambling ID (e.g., the indication 828 of the scrambling ID; e.g., 1006, 1008 in FIG. 10) for at least one of the sensing function, the communication function, or the joint sensing-communication function. As noted herein, the scrambling ID indicated to the receiver node 902 from the transmitter node 904 may be accompanied by an indication of the type of function with which it is associated: a sensing function, a communication function, or a joint sensing-communication function.

At 1412, the transmitter node determines if a sensing function will be performed. If a sensing function will not be performed, flowchart 1400 may continue to 1414; if a sensing function will be performed, flowchart 1400 may continue to 1416. As an example, the determination may be performed, at least in part, by the component 199.

At 1414, the transmitter node obtains an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. As an example, the obtaining may be performed, at least in part, by the component 199. FIGS. 7, 9 illustrate an example of a transmitter node (e.g., the second node 704, the transmitter node 904) obtaining an ID indication with a scrambling ID from a receiver node (e.g., the first node 702, the receiver node 902).

The receiver node 902 may be configured to obtain/receive, and the transmitter node 904 may be configured to transmit/provide, an ID indication, where the ID indication indicates the scrambling ID is at least one of a first cell ID 918 for the DL channel measurement in a cell-common operation, a first UE ID 920 for the DL channel measurement in a UE-dedicated operation, or the first UE ID 920′ for an UL channel measurement. In aspects for a DL channel measurement (e.g., at 928 for a cell-common case), the receiver node 902 (e.g., a UE) may receive an indication 922 that the transmitter node 904 (e.g., network node/base station) may use a cell ID to generate and transmit phase-coded FMCW signals in the DL for the DL channel measurement (at 928) performed by the receiver node 902. In aspects for a DL channel measurement (e.g., at 930 for a UE-dedicated case), the receiver node 902 (e.g., a UE) may receive an indication 924 that the transmitter node 904 (e.g., network node/base station) may use UE ID to generate and transmit phase-coded FMCW signals in the DL for the DL channel measurement (at 930) performed by the receiver node 902. In aspects for a UL channel measurement (at 932), the receiver node 902 (e.g., a UE) may receive an indication 926 from the transmitter node 904 (e.g., network node/base station) to use its UE ID to generate and transmit phase-coded FMCW signals in the UL for the UL channel measurement (at 932) performed at the transmitter node 904.

At 1416, the transmitter node obtains an ID indication, where the ID indication indicates the scrambling ID is a node-specific ID for at least one of the monostatic sensing or the bi-static sensing. As an example, the obtaining may be performed, at least in part, by the component 199. FIGS. 7, 9 illustrate an example of a transmitter node (e.g., the second node 704, the transmitter node 904) obtaining an ID indication with a scrambling ID (e.g., for a receiver node such as the first node 702, the receiver node 902).

In the configuration 940, a receiver node 902 (e.g., a first node which may be a UE) may perform bistatic sensing for JCS on a target 906 with a transmitter node 904 (e.g., a second node which may be a base station). The transmitter node 904 may transmit JCS signals to the receiver node 902, and the receiver of the receiver node 902 may estimate the target 906, while the transmitter node 904 may also detect the target 906 in the echo of the transmitted JCS signals via monostatic sensing. In aspects, the transmitter node 904 may detect the target 906 in the echo of the transmitted JCS signals via monostatic sensing without the receiver node 902 performing bistatic sensing.

In the configuration 950, the receiver node 902 may perform bistatic sensing for JCS on the target 906 with a transmitter node 908 which may also detect the target 906 in the echo of the transmitted JCS signals via monostatic sensing. In aspects, the transmitter node 908 may detect the target 906 in the echo of the transmitted JCS signals via monostatic sensing without the receiver node 902 performing bistatic sensing. It should be noted that aspects herein also contemplate that in the configuration 950 the receiver node 902 may be a base station and the transmitter node 904 may be a UE. In aspects for monostatic sensing, each sensing node performing monostatic sensing may be configured or assigned by the transmitter node 904 a dedicated node-specific ID 912/a dedicated node-specific ID 916 (or sensing ID) for phase-coded FMCW generation and transmission. Each sensing node performing monostatic sensing may be configured to obtain, from a network node (e.g., the transmitter node 904 as a base station), an ID indication, where the ID indication indicates the scrambling ID is the node-specific ID 912/the node-specific ID 916 for the monostatic sensing. In aspects for monostatic sensing, each sensing node performing monostatic sensing may be configured to transmit the set of phase-coded FMCW signals, and to receive the set of phase-coded FMCW signals. In some aspects for bistatic sensing (e.g., a first option), the transmitter node may be configured or assigned a dedicated node-specific ID, the node-specific ID 912/the node-specific ID 916 (or sensing ID), by a network node for phase-coded FMCW generation and transmission. The sensing node may indicate its dedicated node-specific ID (or sensing ID) during the bistatic sensing procedure/session. Each sensing node performing bistatic sensing may be configured to obtain, from a network node (e.g., the transmitter node 904 as a base station), an ID indication, where the ID indication indicates the scrambling ID is the node-specific ID 912/the node-specific ID 916 for the bistatic sensing. In some aspects for bistatic sensing (e.g., a second option), the sensing transmitter node and the sensing receiver node may be configured or assigned a dedicated node-specific ID, a node-specific ID 910/a dedicated node-specific ID 914 (or sensing ID) by a network node (e.g., the transmitter node 904 as a base station) for phase-coded FMCW generation and transmission.

At 1418, the transmitter node modulates the sequence of elements according to the modulated order of the coding waveform to generate a modulated sequence of elements, and generate the coding waveform based on the modulated sequence of elements. As an example, the obtaining may be performed, at least in part, by the component 199. FIGS. 7, 8 illustrate an example of a transmitter node (e.g., the second node 704, the transmitter node 904) performing such a modulation.

In aspects, a sequence (s₁, s₂, . . . sₖ) may be modulated into (ϕ₁, ϕ₂, . . . , ϕₗ, . . . , ϕ_{L}). For example, if ϕ₁∈{0, πt}, then each ϕₗ represents one bit; if ϕₗ∈{0,π/2,π,3π/2}, then each ϕₗ represents two bits, etc. The sequence (s₁, s₂, . . . sₖ) may be regarded as a cell ID for DL operations, a UE ID for UL operations, or a node-specific ID for sensing operations. In aspects, rect

$$( \frac{t - X}{Y} )$$

may represent a rectangular function for a pulse centered at X with a width Y.

In aspects, the sequence (s₁, s₂, . . . sₖ) may represent a cell ID for DL or a UE ID for UL or a node-specific ID for sensing, as described herein. A transmitter node (e.g., the second node 704) may indicate to a receiver node (e.g., the first node 702) how to modulate the sequence (s₁, s₂, . . . sₖ) into (ϕ₁, ϕ₂, . . . , ϕₗ, . . . , ϕ_{L}). The receiver node may receive an indication to report its capability to the transmitter node for a maximum modulated order mₘₐₓ of the phase-coded term for the receiver node. The receiver node may also receive an indication for the maximum modulation order of the coded phase together with the indication of the scrambling ID, or separately with the indication of the scrambling ID. On the other hand, when a receiver node (e.g., as a network node/base station) will receive phase-coded FMCW signals and not provide them, the receiver node may transmit, for the transmitter node (e.g., a UE, a maximum modulated order capability for modulating the sequence of elements, and receive, from the second node, an indication of a modulated order of the coding waveform, where the modulated order of the coding waveform is less than or equal to the maximum modulated order capability. In aspects, when the indicated maximum modulation order is 1 (one), the receiver node may receive/obtain an indication of whether a modulation scheme is utilized as BPSK, or as π/2-BPSK, for the coded phase generation.

At 1420, the transmitter node scrambles the set of FMCW signals based on a scrambling ID associated with at least one of the first node or a second node, where the set of FMCW signals is scrambled to obtain a set of phase-coded FMCW signals. As an example, the descrambling may be performed, at least in part, by the component 199. FIGS. 7, 8 illustrate an example of such a scramble by the transmitter node (e.g., the second node 704) scrambling such a set of FMCW signals.

The transmitter node/the second node 704 may be configured to scramble (or code) (at 708) the set of FMCW signals based on a scrambling ID associated with at least one of the first node or a second node. The set of FMCW signals may be scrambled to obtain a set of phase-coded FMCW signals (e.g., the set of phase-coded FMCW signals 710). In aspects, the phase-coded FMCW signal (e.g., one or more of the set of phase-coded FMCW signals 710) may be represented as:

$${x}_{Tx} ( t ) = C ( t ) cos ( 2 π ( {f}_{c} + \frac{s}{2} t ) t + {ϕ}_{0} ) rect ( \frac{t - T / 2}{T} ) ,$$

where C(t) may represent the phase-coded waveform as:

$${\sum }_{l = 1}^{L} exp ( - j {ϕ}_{l} ) rect ( \frac{t - ( l - 1 / 2 ) \cdot T / L}{T / L} ) ,$$

where L indicates that the FMCW is partitioned into L parts, and each part may be modulated with a different phase.

At 1422, a transmitter node configures a set of FMCW signals. As an example, the configuration may be performed, at least in part, by the component 199. FIGS. 6-9 illustrate an example of a transmitter node (e.g., the second node 704) configuring such a set of FMCW signals.

The second node 704 may be configured to configure (at 706) a set of FMCW signals. In aspects, set of FMCW signals may be configured (at 706) by the second node 704 as:

$${x}_{config} ( t ) = cos ( 2 π ( {f}_{c} + \frac{s}{2} t ) t + {ϕ}_{0} ) rect ( \frac{t - T / 2}{T} ) .$$

The second node 704 may be configured to scramble (or code) (at 708) the set of FMCW signals based on a scrambling ID associated with at least one of the first node or a second node.

At 1424, the transmitter node transmits, for the second node/receiver node, the set of phase-coded FMCW signals. As an example, the transmission may be performed, at least in part, by the component 199. FIG. 7 illustrates an example of a transmitter node (e.g., the second node 704) transmitting such a set of phase-coded FMCW signals.

The second node 704 may be configured to transmit, for the first node 702, the set of phase-coded FMCW signals 710. In aspects, the set of phase-coded FMCW signals 710 may be transmitted to the first node 702 from the second node 704 via RF signaling. In some aspects, the first node 702 may be configured to obtain the set of phase-coded FMCW signals 710 (e.g., in configurations/operations where the first node 702 is a base station). The set of phase-coded FMCW signals 710 may be phase-coded based on a scrambling ID associated with at least one of the first node 702 or the second node 704. In aspects, the set of phase-coded FMCW signals 710 may be utilized in a sensing session (e.g., for JCS).

At 1426, the transmitter node performs at least one of a sensing function, a communication function, or a joint sensing-communication function associated with the set of phase-coded FMCW signals. As an example, the performance may be performed, at least in part, by the component 199. FIGS. 7, 9 illustrate an example of the transmitter node (e.g., the second node 704/the transmitter node 904) performing such functions.

In aspects, the first node 702 may be configured to perform (at 714) at least one of a sensing function, a communication function, or a joint sensing-communication function based on the set of descrambled FMCW signals (e.g., descrambled at 712). In aspects, the sensing function may be monostatic sensing, bistatic sensing (e.g., with and/or by the second node 704, a UE (not shown), and/or the like), the communication function may be UL/DL communication functions such as channel measurements and/or the like, and the joint sensing-communication function may be sensing functions and communication functions that may be performed in the same spectrum. In some aspects, the second node 704 may be configured to perform at least one of a sensing function, a communication function, or a joint sensing-communication function, as described herein.

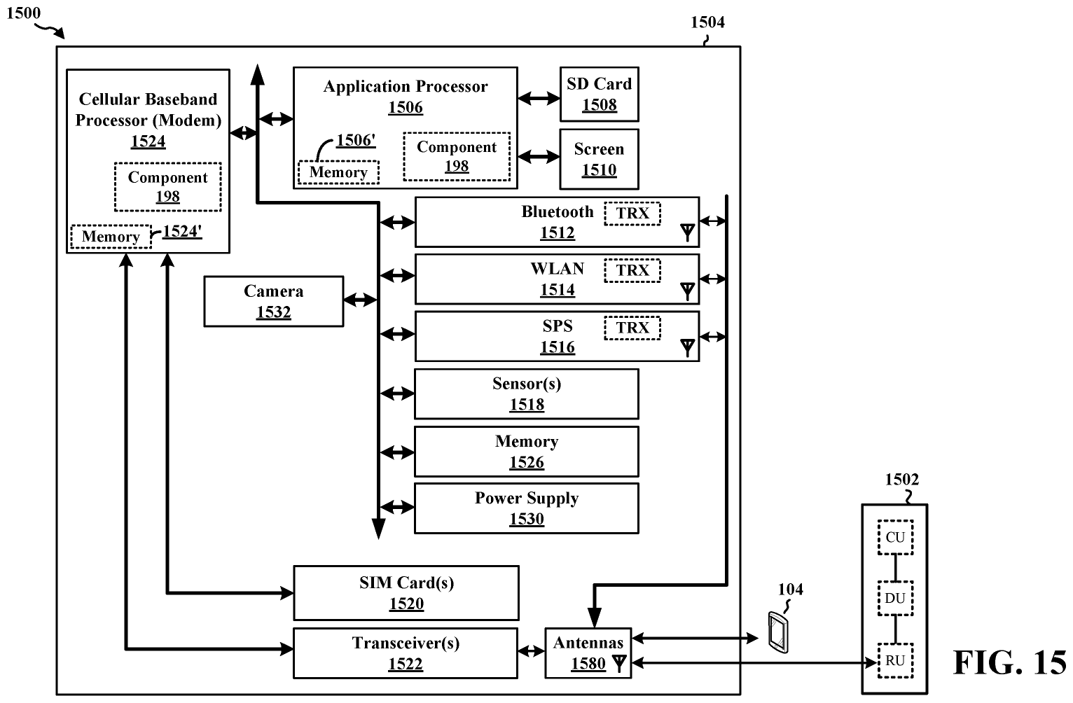

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see UE 350 of FIG. 3) and include the additional modules of the apparatus 1504.

As discussed supra, the component 198 may be configured to obtain a set of phase-coded FMCW signals, where the set of phase-coded FMCW signals is phase-coded based on a scrambling ID associated with at least one of the first node or a second node. The component 198 may also be configured to descramble the set of phase-coded FMCW signals based on the scrambling ID, where the set of phase-coded FMCW signals is descrambled to obtain a set of descrambled FMCW signals. The component 198 may also be configured to perform at least one of a sensing function, a communication function, or a joint sensing-communication function based on the set of descrambled FMCW signals. The component 198 may also be configured to transmit, for the second node, a maximum modulated order capability for modulating the sequence of elements. The component 198 may also be configured to receive, from the second node, an indication of a modulated order of the coding waveform, where the modulated order of the coding waveform is less than or equal to the maximum modulated order capability. The component 198 may also be configured to modulate the sequence of elements according to the modulated order of the coding waveform to generate a modulated sequence of elements. The component 198 may also be configured to generate the decoding waveform based on the modulated sequence of elements. The component 198 may also be configured to receive, from the second node, a maximum modulated order capability for modulating the sequence of elements. The component 198 may also be configured to transmit, for the second node, an indication of a modulated order of the coding waveform, where the modulated order of the coding waveform is less than or equal to the maximum modulated order capability. The component 198 may also be configured to obtain, from a network node, an ID indication, where the ID indication indicates the scrambling ID is a node-specific ID for at least one of the monostatic sensing or the bi-static sensing. The component 198 may also be configured to receive, from the second node, an indication of the scrambling ID for at least one of the sensing function, the communication function, or the joint sensing-communication function. The component 198 may also be configured to obtain an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. The component 198 may be further configured to perform any of the aspects described in connection with the flowcharts in any of FIGS. 11-14, and/or any of the aspects performed by a sensing entity for any of FIGS. 5-10. The component 198 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for obtaining a set of phase-coded FMCW signals, where the set of phase-coded FMCW signals is phase-coded based on a scrambling ID associated with at least one of the first node or a second node. In the configuration, the apparatus 1504, and in particular the cellular baseband processor 1524 and/or the application processor 1506, may include means for descrambling the set of phase-coded FMCW signals based on the scrambling ID, where the set of phase-coded FMCW signals is descrambled to obtain a set of descrambled FMCW signals. In the configuration, the apparatus 1504, and in particular the cellular baseband processor 1524 and/or the application processor 1506, may include means for performing at least one of a sensing function, a communication function, or a joint sensing-communication function based on the set of descrambled FMCW signals. In one configuration, the apparatus 1504, and in particular the cellular baseband processor 1524 and/or the application processor 1506, may include means for transmitting, for the second node, a maximum modulated order capability for modulating the sequence of elements. In one configuration, the apparatus 1504, and in particular the cellular baseband processor 1524 and/or the application processor 1506, may include means for receiving, from the second node, an indication of a modulated order of the coding waveform, where the modulated order of the coding waveform is less than or equal to the maximum modulated order capability. In one configuration, the apparatus 1504, and in particular the cellular baseband processor 1524 and/or the application processor 1506, may include means for modulating the sequence of elements according to the modulated order of the coding waveform to generate a modulated sequence of elements. In one configuration, the apparatus 1504, and in particular the cellular baseband processor 1524 and/or the application processor 1506, may include means for generating the decoding waveform based on the modulated sequence of elements. In one configuration, the apparatus 1504, and in particular the cellular baseband processor 1524 and/or the application processor 1506, may include means for receiving, from the second node, a maximum modulated order capability for modulating the sequence of elements. In one configuration, the apparatus 1504, and in particular the cellular baseband processor 1524 and/or the application processor 1506, may include means for transmitting, for the second node, an indication of a modulated order of the coding waveform, where the modulated order of the coding waveform is less than or equal to the maximum modulated order capability. In one configuration, the apparatus 1504, and in particular the cellular baseband processor 1524 and/or the application processor 1506, may include means for obtaining, from a network node, an ID indication, where the ID indication indicates the scrambling ID is a node-specific ID for at least one of the monostatic sensing or the bi-static sensing. In one configuration, the apparatus 1504, and in particular the cellular baseband processor 1524 and/or the application processor 1506, may include means for receiving, from the second node, an indication of the scrambling ID for at least one of the sensing function, the communication function, or the joint sensing-communication function. In one configuration, the apparatus 1504, and in particular the cellular baseband processor 1524 and/or the application processor 1506, may include means for obtaining an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

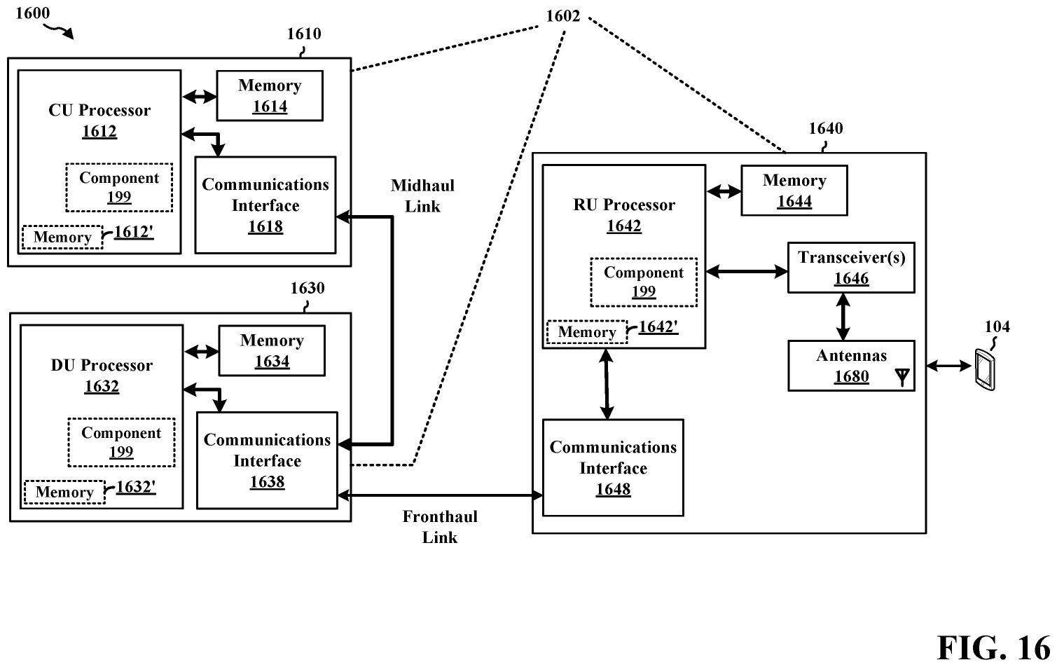

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a set of FMCW signals. The component 199 may be configured to scramble the set of FMCW signals based on a scrambling ID associated with at least one of the first node or a second node, where the set of FMCW signals is scrambled to obtain a set of phase-coded FMCW signals. The component 199 may be configured to transmit, for the second node, the set of phase-coded FMCW signals. The component 199 may be configured to obtain the scrambling ID prior to scrambling the set of FMCW signals, where to scramble the set of FMCW signals, the component 199 may be configured to scramble the set of FMCW signals based on the obtained scrambling ID. The component 199 may be configured to receive, from the second node, a maximum modulated order capability for modulating the sequence of elements. The component 199 may be configured to transmit, for the second node, an indication of a modulated order of the coding waveform, where the modulated order of the coding waveform is less than or equal to the maximum modulated order capability. The component 199 may be configured to modulate the sequence of elements according to the modulated order of the coding waveform to generate a modulated sequence of elements. The component 199 may be configured to generate the coding waveform based on the modulated sequence of elements. The component 199 may be configured to transmit, for the second node, a maximum modulated order capability for modulating the sequence of elements. The component 199 may be configured to receive, from the second node, an indication of a modulated order of the coding waveform, where the modulated order of the coding waveform is less than or equal to the maximum modulated order capability. The component 199 may be configured to perform at least one of a sensing function, a communication function, or a joint sensing-communication function associated with the set of phase-coded FMCW signals. The component 199 may be configured to obtain an ID indication, where the ID indication indicates the scrambling ID is a node-specific ID for at least one of the monostatic sensing or the bi-static sensing. The component 199 may be configured to transmit, for the second node, an indication of the scrambling ID for at least one of the sensing function, the communication function, or the joint sensing-communication function. The component 199 may be configured to obtain an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. The component 199 may be further configured to perform any of the aspects described in connection with the flowcharts in any of FIGS. 11-14, and/or any of the aspects performed by a sensing entity for any of FIGS. 5-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for configuring a set of FMCW signals. In the configuration, the network entity 1602 may include means for scrambling the set of FMCW signals based on a scrambling ID associated with at least one of the first node or a second node, where the set of FMCW signals is scrambled to obtain a set of phase-coded FMCW signals. In the configuration, the network entity 1602 may include means for transmitting, for the second node, the set of phase-coded FMCW signals. In one configuration, the network entity 1602 may include means for obtaining the scrambling ID prior to scrambling the set of FMCW signals, where scrambling the set of FMCW signals includes scrambling the set of FMCW signals based on the obtained scrambling ID. In one configuration, the network entity 1602 may include means for receiving, from the second node, a maximum modulated order capability for modulating the sequence of elements. In one configuration, the network entity 1602 may include means for transmitting, for the second node, an indication of a modulated order of the coding waveform, where the modulated order of the coding waveform is less than or equal to the maximum modulated order capability. In one configuration, the network entity 1602 may include means for modulating the sequence of elements according to the modulated order of the coding waveform to generate a modulated sequence of elements. In one configuration, the network entity 1602 may include means for generating the coding waveform based on the modulated sequence of elements. In one configuration, the network entity 1602 may include means for transmitting, for the second node, a maximum modulated order capability for modulating the sequence of elements. In one configuration, the network entity 1602 may include means for receiving, from the second node, an indication of a modulated order of the coding waveform, where the modulated order of the coding waveform is less than or equal to the maximum modulated order capability. In one configuration, the network entity 1602 may include means for performing at least one of a sensing function, a communication function, or a joint sensing-communication function associated with the set of phase-coded FMCW signals. In one configuration, the network entity 1602 may include means for obtaining an ID indication, where the ID indication indicates the scrambling ID is a node-specific ID for at least one of the monostatic sensing or the bi-static sensing. In one configuration, the network entity 1602 may include means for transmitting, for the second node, an indication of the scrambling ID for at least one of the sensing function, the communication function, or the joint sensing-communication function. In one configuration, the network entity 1602 may include means for obtaining an ID indication, where the ID indication indicates the scrambling ID is at least one of a first cell ID for the DL channel measurement in a cell-common operation, a first UE ID for the DL channel measurement in a UE-dedicated operation, or the first UE ID for the UL channel measurement. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks and/or wireless devices may utilize specific waveforms for communications, such as frequency division multiplexing (OFDM, and for sensing (RF, such as FMCW signals). RF sensing operations may include scanning an area by sweeping across one or more beams. RF waveforms may be utilized for JCS or joint sensing-communications, environment scanning, object detection, weather monitoring, and/or the like. The use of RF waveforms for sensing may provide for low cost, allow flexibility, and allow the re-use of sensing waveforms for multiple purposes. Wireless communication networks may also support and enable RF-based communications between devices thereon. However, as the bandwidth allocated for wireless/cellular communications systems (e.g., in 5G NR, Enhanced 5G (5G+)) becomes larger and more use cases are introduced with wireless/cellular communications systems, joint communication/RF sensing operations (also functions) (e.g., JCS) utilization may increase further for future cellular systems (e.g., in 6G). As noted, FMCW is used in RADAR systems due to its low complexity and low cost, which may be further reused for multiple purposes, e.g., sensing, positioning, communications, JCS, etc. For sensing operations, the coexistence of multiple RADAR in congested wireless traffic may be problematic (e.g., with the increasing number of RADAR-equipped vehicles on roadways). The interference caused by other RADAR may negatively affect sensing functionality of a receiver utilizing RADAR for sensing operations, by decreasing signal detection capability. For communications, a receiver may be unable to detect a UE ID (e.g., in UL signaling) or cell ID (e.g., in DL signaling) when receiving legacy, un-coded FMCW signals transmitted by a transmitter. The received FMCW signals may also be interfered with by other FMCW transmitters.

Various aspects herein for scrambling of FMCW signals for interference mitigation in JCS in wireless communications systems improve communications and sensing in wireless communication networks and wireless devices. In one example, a first node may be configured to obtain a set of phase-coded FMCW signals, where the set of phase-coded FMCW signals is phase-coded based on a scrambling ID associated with at least one of the first node or a second node. The first node may also be configured to descramble the set of phase-coded FMCW signals based on the scrambling ID, where the set of phase-coded FMCW signals is descrambled to obtain a set of descrambled FMCW signals. The first node may also be configured to perform at least one of a sensing function, a communication function, or a joint sensing-communication function based on the set of descrambled FMCW signals. In another example, a first node may be configured to configure a set of FMCW signals. The first node may be configured to scramble the set of FMCW signals based on a scrambling ID associated with at least one of the first node or a second node, where the set of FMCW signals is scrambled to obtain a set of phase-coded FMCW signals. The first node may be configured to transmit, for the second node, the set of phase-coded FMCW signals.

The aspects herein for scrambling of FMCW signals for interference mitigation in JCS improve communications and sensing in wireless communication networks. Aspects provide for utilizing IDs to decode phase-coded FMCW signals to reduce interference for receivers of phase-coded FMCW signals (e.g., increase signal-to-interference ratios SIRs). Additionally, aspects provide for applying the decoding via IDs for phase-coded FMCW signals to sensing functions, communication functions, JCS or joint sensing-communication functions, and/or the like, for utilization of larger and more crowded bandwidths in 5G NR, 5G+, and for 6G operations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communications at a first node, including: obtaining a set of phase-coded frequency modulated continuous wave (FMCW) signals, where the set of phase-coded FMCW signals is phase-coded based on a scrambling identifier (ID) associated with at least one of the first node or a second node; descrambling the set of phase-coded FMCW signals based on the scrambling ID, where the set of phase-coded FMCW signals is descrambled to obtain a set of descrambled FMCW signals; and performing at least one of a sensing function, a communication function, or a joint sensing-communication function based on the set of descrambled FMCW signals.
Aspect 2 is he method of aspect 1, where descrambling the set of phase-coded FMCW signals based on the scrambling ID includes at least one of: mixing an un-coded FMCW signal generated by the first node with the set of phase-coded FMCW signals to obtain a set of mixed FMCW signals; processing the set of mixed FMCW signals through at least one of a low pass filter (LPF) or an analog-to-digital converter (ADC) to obtain a set of processed FMCW signals; adjusting the set of processed FMCW signals with a group delay adjustment to obtain a set of aligned FMCW signals; or applying a decoding waveform based on the scrambling ID to the set of aligned FMCW signals to obtain the set of descrambled FMCW signals.
Aspect 3 is the method of aspect 2, where the set of phase-coded FMCW signals is phase-coded according to a coding waveform that is based on the scrambling ID; and where the decoding waveform is a complex conjugate of the coding waveform.
Aspect 4 is the method of aspect 3, where the scrambling ID corresponds to a sequence of elements associated with the coding waveform; and where the method further includes at least one of: transmitting, for the second node, a maximum modulated order capability for modulating the sequence of elements, receiving, from the second node, an indication of a modulated order of the coding waveform, where the modulated order of the coding waveform is less than or equal to the maximum modulated order capability, modulating the sequence of elements according to the modulated order of the coding waveform to generate a modulated sequence of elements, and generating the decoding waveform based on the modulated sequence of elements; or receiving, from the second node, a maximum modulated order capability for modulating the sequence of elements, and transmitting, for the second node, an indication of the modulated order of the coding waveform, where the modulated order of the coding waveform is less than or equal to the maximum modulated order capability.
Aspect 5 is the method of any of aspects 1 to 4, where at least one of the sensing function, the communication function, or the joint sensing-communication function is associated with monostatic sensing or bi-static sensing.
Aspect 6 is the method of aspect 5, where at least one of the sensing function, the communication function, or the joint sensing-communication function is associated with the monostatic sensing, where the first node and the second node are a same node.
Aspect 7 is the method of aspect 6, where obtaining the set of phase-coded FMCW signals includes: transmitting the set of phase-coded FMCW signals; and receiving the set of phase-coded FMCW signals.
Aspect 8 is the method of aspect 5, where at least one of the sensing function, the communication function, or the joint sensing-communication function is associated with the bi-static sensing, where the first node is different from the second node.
Aspect 9 is the method of aspect 8, where obtaining the set of phase-coded FMCW signals includes: receiving, from the second node, the set of phase-coded FMCW signals.
Aspect 10 is the method of any of aspects 5 to 9, further including at least one of: obtaining, from a network node, an ID indication, where the ID indication indicates the scrambling ID is a node-specific ID for at least one of the monostatic sensing or the bi-static sensing; or receiving, from the second node, an indication of the scrambling ID for at least one of the sensing function, the communication function, or the joint sensing-communication function.
Aspect 11 is the method of any of aspects 1 to 4, where at least one of the sensing function, the communication function, or the joint sensing-communication function is associated with a downlink (DL) channel measurement or an uplink (UL) channel measurement.
Aspect 12 is the method of aspect 11, further including: obtaining an ID indication, where the ID indication indicates the scrambling ID is at least one of a first cell ID for the DL channel measurement in a cell-common operation, a first user equipment (UE) ID for the DL channel measurement in a UE-dedicated operation, or the first UE ID for the UL channel measurement.
Aspect 13 is the method of aspect 12, where the first cell ID for the DL channel measurement in the cell-common operation is different from a second cell ID associated with orthogonal frequency division multiplexing (OFDM)-based operations; where the first UE ID for the DL channel measurement in the UE-dedicated operation is different from a second UE ID associated with the OFDM-based operations; or where the first UE ID for the UL channel measurement is different from the second UE ID associated with the OFDM-based operations.
Aspect 14 is the method of any of aspects 1 to 13, where a single FMCW slope is associated with each configured orthogonal frequency division multiplexing (OFDM) numerology; or where multiple FMCW slopes are associated with each configured OFDM numerology, where obtaining the set of phase-coded FMCW signals includes obtaining a FMCW slope of the multiple FMCW slopes associated with the set of phase-coded FMCW signals, and where descrambling the set of phase-coded FMCW signals includes descrambling the set of phase-coded FMCW signals further based on the FMCW slope.
Aspect 15 is a method of wireless communications at a first node, including: configuring a set of frequency modulated continuous wave (FMCW) signals; scrambling the set of FMCW signals based on a scrambling identifier (ID) associated with at least one of the first node or a second node, where the set of FMCW signals is scrambled to obtain a set of phase-coded FMCW signals; and transmitting, for the second node, the set of phase-coded FMCW signals.
Aspect 16 is the method of aspect 15, further including: obtaining the scrambling ID prior to scrambling the set of FMCW signals, where scrambling the set of FMCW signals includes scrambling the set of FMCW signals based on the obtained scrambling ID.
Aspect 17 is the method of aspect 16, where obtaining the scrambling ID includes: receiving an indication of the scrambling ID prior to scrambling the set of FMCW signals.
Aspect 18 is the method of aspect 16, where obtaining the scrambling ID includes: configuring the scrambling ID prior to scrambling the set of FMCW signals.
Aspect 19 is the method of aspect 16, further including: transmitting, to the second node, an indication of the scrambling ID based on the obtained scrambling ID.
Aspect 20 is the method of any of aspects 15 to 19, where the set of phase-coded FMCW signals is phase-coded according to a coding waveform that is based on the scrambling ID, where the scrambling ID corresponds to a sequence of elements associated with the coding waveform; where the method further includes at least one of: receiving, from the second node, a maximum modulated order capability for modulating the sequence of elements, transmitting, for the second node, an indication of a modulated order of the coding waveform, where the modulated order of the coding waveform is less than or equal to the maximum modulated order capability, modulating the sequence of elements according to the modulated order of the coding waveform to generate a modulated sequence of elements, and generating the coding waveform based on the modulated sequence of elements; or transmitting, for the second node, a maximum modulated order capability for modulating the sequence of elements, and receiving, from the second node, an indication of the modulated order of the coding waveform, where the modulated order of the coding waveform is less than or equal to the maximum modulated order capability.
Aspect 21 is the method of any of aspects 15 to 20, further including: performing at least one of a sensing function, a communication function, or a joint sensing-communication function associated with the set of phase-coded FMCW signals.
Aspect 22 is the method of aspect 21, where at least one of the sensing function, the communication function, or the joint sensing-communication function is associated with monostatic sensing or bi-static sensing.
Aspect 23 is the method of aspect 22, where at least one of the sensing function, the communication function, or the joint sensing-communication function is associated with the monostatic sensing, where the first node and the second node are a same node, and where transmitting the set of phase-coded FMCW signals includes: receiving the set of phase-coded FMCW signals.
Aspect 24 is the method of aspect 22, where at least one of the sensing function, the communication function, or the joint sensing-communication function is associated with the bi-static sensing, where the first node is different from the second node.
Aspect 25 is the method of any of aspects 22 to 24, further including at least one of: obtaining an ID indication, where the ID indication indicates the scrambling ID is a node-specific ID for at least one of the monostatic sensing or the bi-static sensing; or transmitting, for the second node, an indication of the scrambling ID for at least one of the sensing function, the communication function, or the joint sensing-communication function.
Aspect 26 is the method of aspect 21, where at least one of the sensing function, the communication function, or the joint sensing-communication function is associated with a downlink (DL) channel measurement or an uplink (UL) channel measurement; where the method further includes: obtaining an ID indication, where the ID indication indicates the scrambling ID is at least one of a first cell ID for the DL channel measurement in a cell-common operation, a first user equipment (UE) ID for the DL channel measurement in a UE-dedicated operation, or the first UE ID for the UL channel measurement.
Aspect 27 is the method of aspect 26, where the first cell ID for the DL channel measurement in the cell-common operation is different from a second cell ID associated with orthogonal frequency division multiplexing (OFDM)-based operations; where the first UE ID for the DL channel measurement in the UE-dedicated operation is different from a second UE ID associated with the OFDM-based operations; or where the first UE ID for the UL channel measurement is different from the second UE ID associated with the OFDM-based operations.
Aspect 28 is the method of any of aspects 15 to 27, where a single FMCW slope is associated with each configured orthogonal frequency division multiplexing (OFDM) numerology; or where multiple FMCW slopes are associated with each configured OFDM numerology, where scrambling the set of FMCW signals includes scrambling the set of FMCW signals further based on a FMCW slope of the multiple FMCW slopes associated with the set of phase-coded FMCW signals, and where transmitting the set of phase-coded FMCW signals includes transmitting the FMCW slope.
Aspect 29 is an apparatus for wireless communication including means for implementing any of aspects 1 to 14.
Aspect 30 is a computer-readable medium (e.g., a non-transitory computer-readable medium) storing computer executable code, the code when executed by at least one processor causes the at least one processor to implement any of aspects 1 to 14.
Aspect 31 is an apparatus for wireless communication at a network node. The apparatus includes a memory; and at least one processor coupled to the memory and, based at least in part on information stored in the memory, the at least one processor is configured to implement any of aspects 1 to 14.
Aspect 32 is the apparatus of aspect 31, further including at least one of a transceiver or an antenna coupled to the at least one processor.
Aspect 33 is an apparatus for wireless communication including means for implementing any of aspects 15 to 28.
Aspect 34 is a computer-readable medium (e.g., a non-transitory computer-readable medium) storing computer executable code, the code when executed by at least one processor causes the at least one processor to implement any of aspects 15 to 28.
Aspect 35 is an apparatus for wireless communication at a network node. The apparatus includes a memory; and at least one processor coupled to the memory and, based at least in part on information stored in the memory, the at least one processor is configured to implement any of aspects 15 to 28.
Aspect 36 is the apparatus of aspect 35, further including at least one of a transceiver or an antenna coupled to the at least one processor.

What is claimed is:

1. An apparatus for wireless communications at a first node, comprising:
a memory; and
at least one processor coupled to the memory and, based at least in part on information stored in the memory, the at least one processor is configured to:
obtain a set of phase-coded frequency modulated continuous wave (FMCW) signals, wherein the set of phase-coded FMCW signals is phase-coded based on a scrambling identifier (ID) associated with at least one of the first node or a second node;
descramble the set of phase-coded FMCW signals based on the scrambling ID, wherein the set of phase-coded FMCW signals is descrambled to obtain a set of descrambled FMCW signals; and
perform at least one of a sensing function, a communication function, or a joint sensing-communication function based on the set of descrambled FMCW signals.

2. The apparatus of claim 1, wherein to descramble the set of phase-coded FMCW signals based on the scrambling ID, the at least one processor is configured to perform at least one of:
mix an un-coded FMCW signal generated by the first node with the set of phase-coded FMCW signals to obtain a set of mixed FMCW signals;
process the set of mixed FMCW signals through at least one of a low pass filter (LPF) or an analog-to-digital converter (ADC) to obtain a set of processed FMCW signals;
adjust the set of processed FMCW signals with a group delay adjustment to obtain a set of aligned FMCW signals; or
apply a decoding waveform based on the scrambling ID to the set of aligned FMCW signals to obtain the set of descrambled FMCW signals.

3. The apparatus of claim 2, wherein the set of phase-coded FMCW signals is phase-coded according to a coding waveform that is based on the scrambling ID; and
wherein the decoding waveform is a complex conjugate of the coding waveform.

4. The apparatus of claim 3, wherein the scrambling ID corresponds to a sequence of elements associated with the coding waveform; and
wherein the at least one processor is further configured to perform at least one of:
transmit, for the second node, a maximum modulated order capability for modulating the sequence of elements,
receive, from the second node, an indication of a modulated order of the coding waveform, wherein the modulated order of the coding waveform is less than or equal to the maximum modulated order capability,
modulate the sequence of elements according to the modulated order of the coding waveform to generate a modulated sequence of elements, and
generate the decoding waveform based on the modulated sequence of elements; or
receive, from the second node, the maximum modulated order capability for modulating the sequence of elements, and
transmit, for the second node, the indication of the modulated order of the coding waveform, wherein the modulated order of the coding waveform is less than or equal to the maximum modulated order capability.

5. The apparatus of claim 1, wherein at least one of the sensing function, the communication function, or the joint sensing-communication function is associated with monostatic sensing or bi-static sensing.

6. The apparatus of claim 5, wherein at least one of the sensing function, the communication function, or the joint sensing-communication function is associated with the monostatic sensing, wherein the first node and the second node are a same node.

7. The apparatus of claim 6, further including at least one of a transceiver or an antenna coupled to the at least one processor, wherein to obtain the set of phase-coded FMCW signals, the at least one processor is configured to:
transmit, via at least one of the transceiver or the antenna, the set of phase-coded FMCW signals; and
receive, via at least one of the transceiver or the antenna, the set of phase-coded FMCW signals.

8. The apparatus of claim 5, wherein at least one of the sensing function, the communication function, or the joint sensing-communication function is associated with the bi-static sensing, wherein the first node is different from the second node.

9. The apparatus of claim 8, wherein to obtain the set of phase-coded FMCW signals, the at least one processor is configured to: receive, from the second node, the set of phase-coded FMCW signals.

10. The apparatus of claim 5, wherein the at least one processor is configured to perform at least one of:
obtain, from a network node, an ID indication, wherein the ID indication indicates the scrambling ID is a node-specific ID for at least one of the monostatic sensing or the bi-static sensing; or
receive, from the second node, an indication of the scrambling ID for at least one of the sensing function, the communication function, or the joint sensing-communication function.

11. The apparatus of claim 1, wherein at least one of the sensing function, the communication function, or the joint sensing-communication function is associated with a downlink (DL) channel measurement or an uplink (UL) channel measurement.

12. The apparatus of claim 11, the at least one processor is further configured to:
obtain an ID indication, wherein the ID indication indicates the scrambling ID is at least one of a first cell ID for the DL channel measurement in a cell-common operation, a first user equipment (UE) ID for the DL channel measurement in a UE-dedicated operation, or the first UE ID for the UL channel measurement.

13. The apparatus of claim 12, wherein the first cell ID for the DL channel measurement in the cell-common operation is different from a second cell ID associated with orthogonal frequency division multiplexing (OFDM)-based operations;
wherein the first UE ID for the DL channel measurement in the UE-dedicated operation is different from a second UE ID associated with the OFDM-based operations; or
wherein the first UE ID for the UL channel measurement is different from the second UE ID associated with the OFDM-based operations.

14. The apparatus of claim 1, wherein a single FMCW slope is associated with each configured orthogonal frequency division multiplexing (OFDM) numerology; or
wherein multiple FMCW slopes are associated with each configured OFDM numerology, wherein to obtain the set of phase-coded FMCW signals, the at least one processor is configured to obtain a FMCW slope of the multiple FMCW slopes associated with the set of phase-coded FMCW signals, and wherein to descramble the set of phase-coded FMCW signals, the at least one processor is configured to descramble the set of phase-coded FMCW signals further based on the FMCW slope.

15. An apparatus for wireless communications at a first node, comprising:
a memory; and
at least one processor coupled to the memory and, based at least in part on information stored in the memory, the at least one processor is configured to:
configure a set of frequency modulated continuous wave (FMCW) signals;
scramble the set of FMCW signals based on a scrambling identifier (ID) associated with at least one of the first node or a second node, wherein the set of FMCW signals is scrambled to obtain a set of phase-coded FMCW signals; and
transmit, for the second node, the set of phase-coded FMCW signals.

16. The apparatus of claim 15, wherein the at least one processor is configured further to:
obtain the scrambling ID prior to scrambling the set of FMCW signals, wherein to scramble the set of FMCW signals, the at least one processor is configured to scramble the set of FMCW signals based on the obtained scrambling ID.

17. The apparatus of claim 16, wherein to obtain the scrambling ID, the at least one processor is configured to: receive an indication of the scrambling ID prior to scrambling the set of FMCW signals.

18. The apparatus of claim 16, wherein to obtain the scrambling ID, the at least one processor is configured to: configure the scrambling ID prior to scrambling the set of FMCW signals.

19. The apparatus of claim 16, further including at least one of a transceiver or an antenna coupled to the at least one processor, wherein the at least one processor is further configured to:
transmit, to the second node via at least one of the transceiver or the antenna, an indication of the scrambling ID based on the obtained scrambling ID.

20. The apparatus of claim 15, wherein the set of phase-coded FMCW signals is phase-coded according to a coding waveform that is based on the scrambling ID, wherein the scrambling ID corresponds to a sequence of elements associated with the coding waveform;
wherein the at least one processor is further configured to perform at least one of:
receive, from the second node, a maximum modulated order capability for modulating the sequence of elements,
transmit, for the second node, an indication of a modulated order of the coding waveform, wherein the modulated order of the coding waveform is less than or equal to the maximum modulated order capability,
modulate the sequence of elements according to the modulated order of the coding waveform to generate a modulated sequence of elements, and
generate the coding waveform based on the modulated sequence of elements; or
transmit, for the second node, the maximum modulated order capability for modulating the sequence of elements, and
receive, from the second node, the indication of the modulated order of the coding waveform, wherein the modulated order of the coding waveform is less than or equal to the maximum modulated order capability.

21. The apparatus of claim 15, wherein the at least one processor is further configured to:
perform at least one of a sensing function, a communication function, or a joint sensing-communication function associated with the set of phase-coded FMCW signals.

22. The apparatus of claim 21, wherein at least one of the sensing function, the communication function, or the joint sensing-communication function is associated with monostatic sensing or bi-static sensing.

23. The apparatus of claim 22, wherein at least one of the sensing function, the communication function, or the joint sensing-communication function is associated with the monostatic sensing, wherein the first node and the second node are a same node, and wherein to transmit the set of phase-coded FMCW signals, the at least one processor is configured to: receive the set of phase-coded FMCW signals.

24. The apparatus of claim 22, wherein at least one of the sensing function, the communication function, or the joint sensing-communication function is associated with the bi-static sensing, wherein the first node is different from the second node.

25. The apparatus of claim 22, wherein the at least one processor is further configured to perform at least one of:
obtain an ID indication, wherein the ID indication indicates the scrambling ID is a node-specific ID for at least one of the monostatic sensing or the bi-static sensing; or
transmit, for the second node, an indication of the scrambling ID for at least one of the sensing function, the communication function, or the joint sensing-communication function.

26. The apparatus of claim 21, wherein at least one of the sensing function, the communication function, or the joint sensing-communication function is associated with a downlink (DL) channel measurement or an uplink (UL) channel measurement;
wherein the at least one processor is further configured to:
obtain an ID indication, wherein the ID indication indicates the scrambling ID is at least one of a first cell ID for the DL channel measurement in a cell-common operation, a first user equipment (UE) ID for the DL channel measurement in a UE-dedicated operation, or the first UE ID for the UL channel measurement.

27. The apparatus of claim 26, wherein the first cell ID for the DL channel measurement in the cell-common operation is different from a second cell ID associated with orthogonal frequency division multiplexing (OFDM)-based operations;
wherein the first UE ID for the DL channel measurement in the UE-dedicated operation is different from a second UE ID associated with the OFDM-based operations; or
wherein the first UE ID for the UL channel measurement is different from the second UE ID associated with the OFDM-based operations.

28. The apparatus of claim 15, wherein a single FMCW slope is associated with each configured orthogonal frequency division multiplexing (OFDM) numerology; or
wherein multiple FMCW slopes are associated with each configured OFDM numerology, wherein to scramble the set of FMCW signals, the at least one processor is configured to scramble the set of FMCW signals further based on a FMCW slope of the multiple FMCW slopes associated with the set of phase-coded FMCW signals, and wherein to transmit the set of phase-coded FMCW signals, the at least one processor is configured to transmit the FMCW slope.

29. A method of wireless communications at a first node, comprising:
obtaining a set of phase-coded frequency modulated continuous wave (FMCW) signals, wherein the set of phase-coded FMCW signals is phase-coded based on a scrambling identifier (ID) associated with at least one of the first node or a second node;
descrambling the set of phase-coded FMCW signals based on the scrambling ID, wherein the set of phase-coded FMCW signals is descrambled to obtain a set of descrambled FMCW signals; and
performing at least one of a sensing function, a communication function, or a joint sensing-communication function based on the set of descrambled FMCW signals.

30. A method of wireless communications at a first node, comprising:
configuring a set of frequency modulated continuous wave (FMCW) signals;
scrambling the set of FMCW signals based on a scrambling identifier (ID) associated with at least one of the first node or a second node, wherein the set of FMCW signals is scrambled to obtain a set of phase-coded FMCW signals; and
transmitting, for the second node, the set of phase-coded FMCW signals.
